(19) United States
(12) Patent Application Publication
(10) Pub. No.: US 2015/0201330 A1
(43) Pub. Date: Jul. 16, 2015

(54) COMMUNICATION APPARATUS AND CONTROL METHOD THEREFOR

(71) Applicant: CANON KABUSHIKI KAISHA, Tokyo (JP)

(72) Inventor: Takumi Iko, Yokohama-shi (JP)

(21) Appl. No.: 14/589,390

(22) Filed: Jan. 5, 2015

(30) Foreign Application Priority Data
Jan. 15, 2014 (JP) 2014-005445

(51) Int. Cl. H04W 12/08; H04L 29/06

(52) U.S. Cl. CPC H04W 12/08; H04L 63/0428

(57) ABSTRACT

There is provided a communication apparatus. A forming unit forms a wireless network in which the communication apparatus functions as a relay apparatus and in which a communication partner apparatus is able to join using a network identifier of the wireless network. An encryption unit encrypts communication in the wireless network. A setting unit sets whether or not to apply the encryption of the communication with the encryption unit in accordance with an instruction from a user. The forming unit forms a wireless network that has a different network identifier depending on whether or not the encryption of the communication is applied.

### BACKGROUND OF THE INVENTION

1. Field of the Invention

The present invention relates to a communication apparatus and a control method therefor.

2. Description of the Related Art

In an image capturing apparatus, such as a digital camera, provided with a wireless communication apparatus, captured image data is generally recorded as a file into a recording medium, such as a memory card, built in or attached to the camera. As the image data is in a file format, the image data can easily be transmitted/received via communication.

Furthermore, in some cases, a wireless communication apparatus has a simple access point function. When the wireless communication apparatus activates the simple access point function, another apparatus detects the wireless communication apparatus as an access point and joins in a network formed by the wireless communication apparatus. In this way, wireless communication apparatuses can establish connection with one another in an environment with no wireless network formed by access points. Also, in general, a wireless communication apparatus often stores a network parameter of a wireless network in which it has joined at the time of participation in the wireless network, and refers to and uses the stored network parameter to join in the same wireless network for the second time onward.

When a wireless communication apparatus activates a simple access point function, the encryption setting of a wireless network to be formed can be enabled/disabled in some cases. For example, when another wireless communication apparatus joins in a wireless network in which the encryption setting is enabled, another wireless communication apparatus stores a network parameter such as an encryption key. When another wireless communication apparatus joins in the same wireless network for the second time onward, the stored encryption key is used, and hence a user need not input the encryption key again. However, if the encryption setting of this wireless network is changed to a disabled state, when another wireless communication apparatus joins in this wireless network, the stored network parameter may be rewritten and the stored encryption key may be lost. For this reason, when the encryption setting of a wireless network is changed, it is desirable that the post-change wireless network be distinguished by another device as a wireless network different from the pre-change wireless network.

For example, Japanese Patent Laid-Open No. 2008-79314 describes a technique in which a wireless communication terminal apparatus adds a pattern to a network identifier for distinguishing a wireless network to which it belongs, or deletes a pattern included in the network identifier. According to Japanese Patent Laid-Open No. 2008-79314, a new network identifier is generated by such addition or deletion.

However, the description of the above-referenced Japanese Patent Laid-Open No. 2008-79314 merely relates to a wireless communication terminal apparatus generating a new network identifier from an identifier of a wireless network to which it belongs. Japanese Patent Laid-Open No. 2008-79314 does not take into consideration a wireless communication terminal apparatus using different network identifiers depending on the encryption setting of a wireless network to be formed.

### SUMMARY OF THE INVENTION

The present invention has been made in view of the above circumstances, and provides a technique to, when the encryption setting of a wireless network is changed, suppress the loss of a network parameter stored in a wireless communication apparatus that connected to the pre-change wireless network.

According to an aspect of the present invention, there is provided a communication apparatus comprising: a forming unit configured to form a wireless network in which the communication apparatus functions as a relay apparatus and in which a communication partner apparatus is able to join using a network identifier of the wireless network; an encryption unit configured to encrypt communication in the wireless network; and a setting unit configured to set whether or not to apply the encryption of the communication with the encryption unit in accordance with an instruction from a user, wherein the forming unit forms a wireless network that has a different network identifier depending on whether or not the encryption of the communication is applied.

According to another aspect of the present invention, there is provided a control method for a communication apparatus, the control method comprising: forming a wireless network in which the communication apparatus functions as a relay apparatus and in which a communication partner apparatus is able to join using a network identifier of the wireless network; encrypting communication in the wireless network; and setting whether or not to apply the encryption of the communication in the encrypting in accordance with an instruction from a user, wherein in the forming, a wireless network is formed that has a different network identifier depending on whether or not the encryption of the communication is applied.

Further features of the present invention will become apparent from the following description of exemplary embodiments with reference to the attached drawings.

### BRIEF DESCRIPTION OF THE DRAWINGS

FIG. 1 is a block diagram showing a configuration of an image capturing apparatus (digital camera 100) according to a first embodiment.

FIG. 2 is a block diagram showing a configuration of a mobile telephone 200 according to the first embodiment.

FIGS. 3A and 3B show network configurations according to the first embodiment.

FIGS. 4A to 4C are conceptual diagrams of databases retained by the digital camera 100 according to the first embodiment.

FIG. 5A is a flowchart showing processing in which the digital camera 100 communicates with a new communication apparatus.

FIG. 5B is a flowchart showing processing in which the digital camera 100 communicates with a new communication apparatus.

FIG. 5C is a flowchart showing processing in which the digital camera 100 communicates with a new communication apparatus.

FIGS. 6A to 6K show examples of screens that are displayed on a display unit 106 of the digital camera 100.

FIG. 7A is a flowchart showing processing in which the digital camera 100 communicates again with a communication apparatus with which it has communicated before.

FIG. 7B is a flowchart showing processing in which the digital camera 100 communicates again with a communication apparatus with which it has communicated before.

FIG. 7C is a flowchart showing processing in which the digital camera 100 communicates again with a communication apparatus with which it has communicated before.

FIG. 8 shows an example of a screen that is displayed on the display unit 106 at the time of configuration of the encryption setting of a wireless LAN network.

FIGS. 9A to 9C show examples of identifiers of a network formed by the digital camera 100.

FIGS. 10A and 10B show examples of screens that are displayed on a display unit 206 of the mobile telephone 200.

FIGS. 11A to 11C are conceptual diagrams of databases retained by the digital camera 100 according to a second embodiment.

### DESCRIPTION OF THE EMBODIMENTS

Embodiments of the present invention will now be described with reference to the attached drawings. It should be noted that the technical scope of the present invention is defined by the claims, and is not limited by any of the embodiments described below. In addition, not all combinations of the features described in the embodiments are necessarily required for realizing the present invention.

While the following describes embodiments in which a communication apparatus of the present invention is provided in, for example, an image capturing apparatus such as a digital camera, no limitation is intended in this regard. The present invention is also applicable to, for example, an information processing apparatus such as a mobile telephone, a mobile media player, a so-called tablet device, a printer, and a personal computer.

### First Embodiment

### Configuration of Image Capturing Apparatus

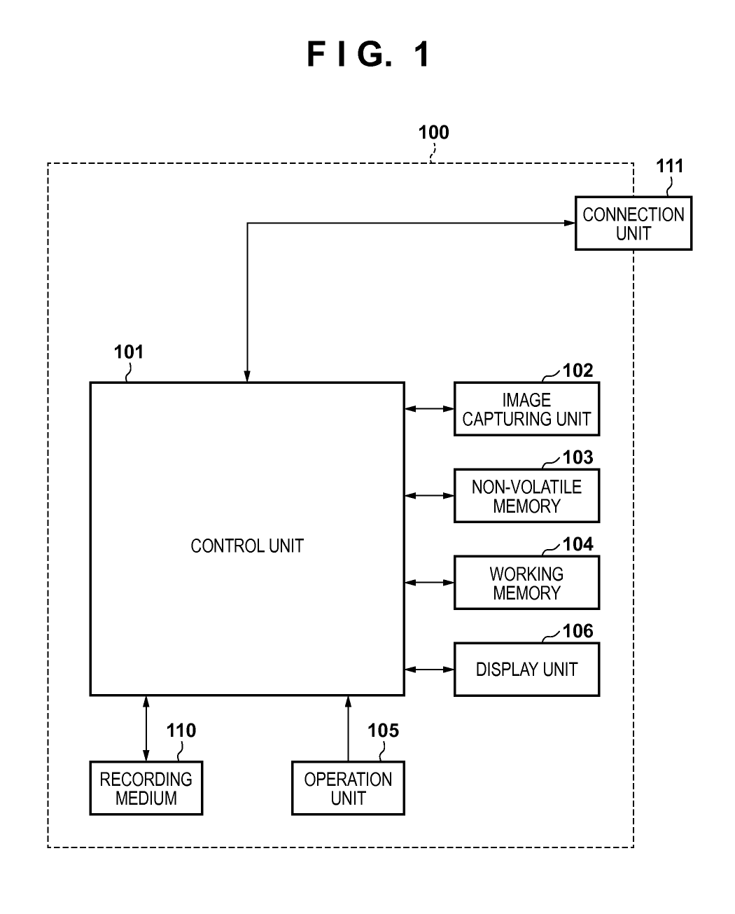

With reference to FIG. 1, the following describes an outline of a configuration and functions of an image capturing apparatus (digital camera 100) according to a first embodiment.

In FIG. 1, a control unit 101 controls components of the digital camera 100 in accordance with an input signal and a later-described program. It should be noted that the entire apparatus may be controlled by a plurality of items of hardware sharing processing, in place of the control unit 101.

An image capturing unit 102 converts light of a subject focused by a lens included in the image capturing unit 102 into an electrical signal, applies noise reduction processing and the like, and outputs digital data as image data. After captured image data is stored into a buffer memory, the control unit 101 applies predetermined calculation to the captured image data, and then the captured image data is recorded into a recording medium 110.

A non-volatile memory 103 is an electrically erasable and recordable non-volatile memory, and stores, for example, a later-described program executed by the control unit 101.

A working memory 104 is used as a buffer memory that temporarily retains image data captured by the image capturing unit 102, an image display memory for a display unit 106, a working area for the control unit 101, and the like.

An operation unit 105 is used to accept a user instruction for the digital camera 100 from a user. The operation unit 105 includes, for example, operation members such as a power button with which the user issues an instruction for turning on/off the power of the digital camera 100, a release switch with which the user issues an image capture instruction, and a reproduction button with which the user issues an instruction for reproducing image data. The operation unit 105 also includes a touchscreen formed on the later-described display unit 106. It should be noted that the release switch has SW1 and SW2. SW1 is turned on when the release switch is pressed halfway down. In this way, an instruction for preparation of image capture, such as AF (autofocus) processing, AE (automatic exposure) processing, AWB (automatic white balance) processing, and EF (pre-flashing) processing, is accepted. On the other hand, SW2 is turned on when the release switch is pressed all the way down. In this way, an instruction for image capture is accepted.

The display unit 106 displays a viewfinder image at the time of image capture, captured image data, characters for an interactive operation screen, and the like. It should be noted that the display unit 106 need not necessary be built in the digital camera 100. It is sufficient for the digital camera 100 to be connectable to an internal or external display unit 106 and to have at least a display control function for controlling display on the display unit 106.

Image data output from the image capturing unit 102 can be recorded into the recording medium 110. The recording medium 110 may be configured in such a manner that it is attachable to and detachable from the digital camera 100, or may be built in the digital camera 100. That is to say, it is sufficient for the digital camera 100 to at least have a unit that accesses the recording medium 110.

A connection unit 111 is an interface for connecting to an external apparatus. The digital camera 100 according to the present embodiment can exchange data with an external apparatus via the connection unit 111. It should be noted that, in the present embodiment, the connection unit 111 includes an interface for communicating with an external apparatus via a wireless LAN. The control unit 101 realizes wireless communication with an external apparatus by controlling the connection unit 111. It should be noted that a communication scheme is not limited to the wireless LAN.

It should be noted that the digital camera 100 according to the present embodiment can operate as a slave apparatus in a wireless LAN infrastructure mode. When it operates as a slave apparatus, it can join in a network formed by a nearby access point (hereinafter, AP) by connecting to that AP. While the digital camera 100 according to the present embodiment is one type of AP, it can also operate as a simple AP with more limited functions. It should be noted that an AP according to the present embodiment is one example of a relay apparatus. When the digital camera 100 operates as a simple AP, the digital camera 100 forms a network by itself. Apparatuses nearby the digital camera 100 recognize the digital camera 100 as an AP, and can join in the network formed by the digital camera 100. As described above, it is assumed that a program for causing the digital camera 100 to operate is retained in the non-volatile memory 103.

While the digital camera 100 according to the present embodiment is one type of AP, it is a simple AP that does not have a gateway function for transferring data received from a slave apparatus to an Internet provider and the like. Therefore, even if it has received data from another apparatus participating in the network it has formed, it cannot transfer the received data to a network such as the Internet. It should be noted that, in another embodiment, the digital camera 100 may have the gateway function.

<Configuration of Mobile Telephone>

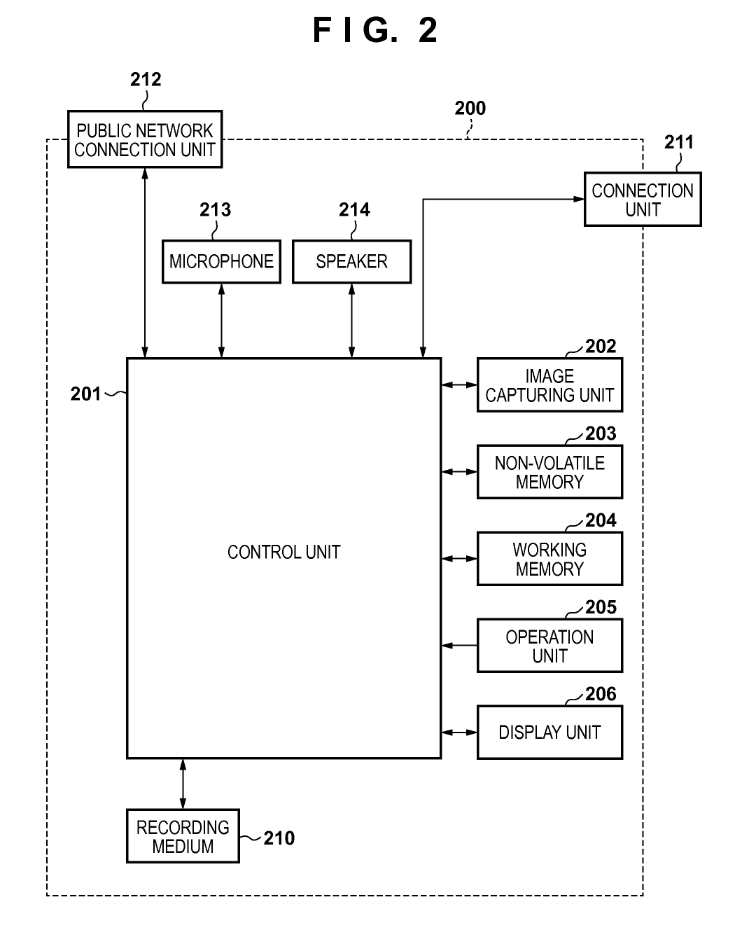

Next, with reference to FIG. 2, a description is given of a configuration and functions of a mobile telephone 200 according to one embodiment to which a connection device of the present invention is applied. While the following describes a mobile telephone as one example of the connection device of the present invention, no limitation is intended in this regard. The present invention is also applicable to, for example, an information processing apparatus such as a digital camera with wireless functions, a mobile media player, a so-called tablet device, a personal computer, and a smartphone.

In FIG. 2, a control unit 201 controls components of the mobile telephone 200 in accordance with an input signal and a later-described program. It should be noted that the entire apparatus may be controlled by a plurality of items of hardware sharing processing, in place of the control unit 201.

An image capturing unit 202 converts light of a subject focused by a lens included in the image capturing unit 202 into an electrical signal, applies noise reduction processing and the like, and outputs digital data as image data. After captured image data is stored into a buffer memory, the control unit 201 applies predetermined calculation to the captured image data, and then the captured image data is recorded into a recording medium 210.

A non-volatile memory 203 is an electrically erasable and recordable non-volatile memory, and stores, for example, various types of programs executed by the control unit 201. It is assumed that a program for communicating with the digital camera 100 is also retained in the non-volatile memory 203 and is installed as a camera communication application. It should be noted that processing of the mobile telephone 200 according to the present embodiment is realized by reading a program provided by the camera communication application. It is assumed that the camera communication application has a program for using basic functions of an OS installed in the mobile telephone 200. It should be noted that the OS of the mobile telephone 200 may have a program for realizing processing according to the present embodiment.

A working memory 204 is used as a buffer memory that temporarily stores image data generated by the image capturing unit 202, an image display memory for a display unit 206, a working area for the control unit 201, and the like.

An operation unit 205 is used to accept an instruction for the mobile telephone 200 from a user. The operation unit 205 includes, for example, operation members such as a power button with which the user issues an instruction for turning on/off the power of the mobile telephone 200, and a touchscreen formed on the display unit 206.

The display unit 206 displays image data, characters for an interactive operation, and the like. It should be noted that the display unit 206 need not necessary be built in the mobile telephone 200. It is sufficient for the mobile telephone 200 to be connectable to the display unit 206 and to have at least a display control function for controlling display on the display unit 206.

Image data output from the image capturing unit 202 can be recorded into the recording medium 210. The recording medium 210 may be configured in such a manner that it is attachable to and detachable from the mobile telephone 200, or may be built in the mobile telephone 200. That is to say, it is sufficient for the mobile telephone 200 to at least have a unit that accesses the recording medium 210.

A connection unit 211 is an interface for connecting to an external apparatus. The mobile telephone 200 according to the present embodiment can exchange data with an external apparatus via the connection unit 211. It should be noted that, in the present embodiment, the connection unit 211 includes an interface for communicating with an external apparatus via a wireless LAN. The control unit 201 realizes wireless communication with an external apparatus by controlling the connection unit 211. It should be noted that the mobile telephone 200 according to the present embodiment can at least operate as a slave apparatus in an infrastructure mode, and can join in a network formed by a nearby AP.

A public network connection unit 212 is an interface used in public wireless communication. The mobile telephone 200 can make/receive calls to/from another device and perform data communication with another device via the public network connection unit 212. At the time of making/receiving calls, the control unit 201 inputs and outputs a sound signal via a microphone 213 and a speaker 214. It is assumed in the present embodiment that the public network connection unit 212 includes an interface for performing 3G communication. It should be noted that a communication scheme is not limited to 3G, and other so-called 4G communication schemes such as LTE, WiMAX, ADSL, and FTTH may be used. Furthermore, the connection unit 211 and the public network connection unit 212 need not necessarily be constructed by independent hardware, and can also be, for example, incorporated into a single antenna.

<System Configuration>

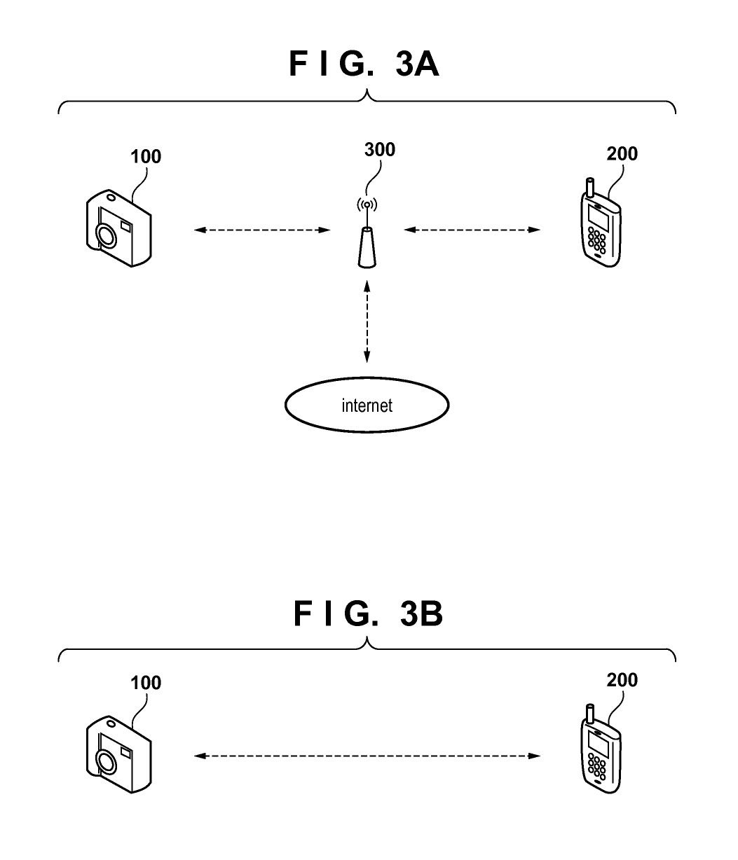

With reference to FIGS. 3A and 3B, the following describes a system configuration in which the digital camera 100 and the mobile telephone 200 according to the present embodiment are connected.

In a case where the digital camera 100 and the mobile telephone 200 transmit/receive data via a wireless LAN, there are two possible forms of data communication shown in FIGS. 3A and 3B.

FIG. 3A shows a first form of data communication in which the digital camera 100 and the mobile telephone 200 join in a wireless LAN network formed by an external AP 300, which is one example of an external relay apparatus. The digital camera 100 and the mobile telephone 200 detect a beacon signal that is periodically transmitted by the external AP 300, and join in the wireless LAN network formed by the external AP 300. Once the digital camera 100 and the mobile telephone 200 have joined in the same wireless LAN network, they can transmit/receive data (establish inter-device connection) via the wireless LAN after, for example, discovering each other and obtaining device abilities from each other.

Also, the external AP 300 according to the present embodiment can connect to an external network, such as the Internet, using a public network and the like. Therefore, the mobile telephone 200 can transmit data over the Internet via the external AP 300.

FIG. 3B shows a second form of data communication in which the digital camera 100 and the mobile telephone 200 connect directly to each other without the external AP 300. In this case, the digital camera 100 operates as a simple AP and forms a wireless LAN network. When the digital camera 100 operates as a simple AP, it starts to periodically transmit a beacon signal. The mobile telephone 200 detects the beacon signal, and joins in the wireless LAN network formed by the digital camera 100. Similarly to the case of FIG. 3A, they can establish connection and transmit/receive data after, for example, discovering each other and obtaining device abilities from each other.

As stated earlier, the digital camera 100 according to the present embodiment does not have a function for communicating with an external network such as the Internet. Therefore, when the mobile telephone 200 is participating in a wireless LAN network formed by the digital camera 100, it cannot transmit data to the Internet and the like via the simple AP.

As described above, the digital camera 100 and the mobile telephone 200 use two forms of data communication. When the digital camera 100 operates as a simple AP, it can enable/disable the encryption setting of a formed wireless LAN network. The digital camera 100 uses different network identifiers for the formed wireless LAN network depending on whether the encryption setting is enabled or disabled. The mobile telephone 200, which is a communication partner apparatus, can join in the wireless LAN network formed by the digital camera 100 using a network identifier. In the present embodiment, a network identifier is assumed to be, but not limited to, an ESSID. In the present embodiment, in order to use different ESSIDs depending on whether the encryption setting is enabled or disabled, the digital camera 100 stores an ESSID for a case in which the encryption setting is enabled, and converts the stored ESSID into another ESSID when the encryption setting is disabled. However, the digital camera 100 may use any method as long as different ESSIDs are used depending on whether the encryption setting is enabled or disabled.

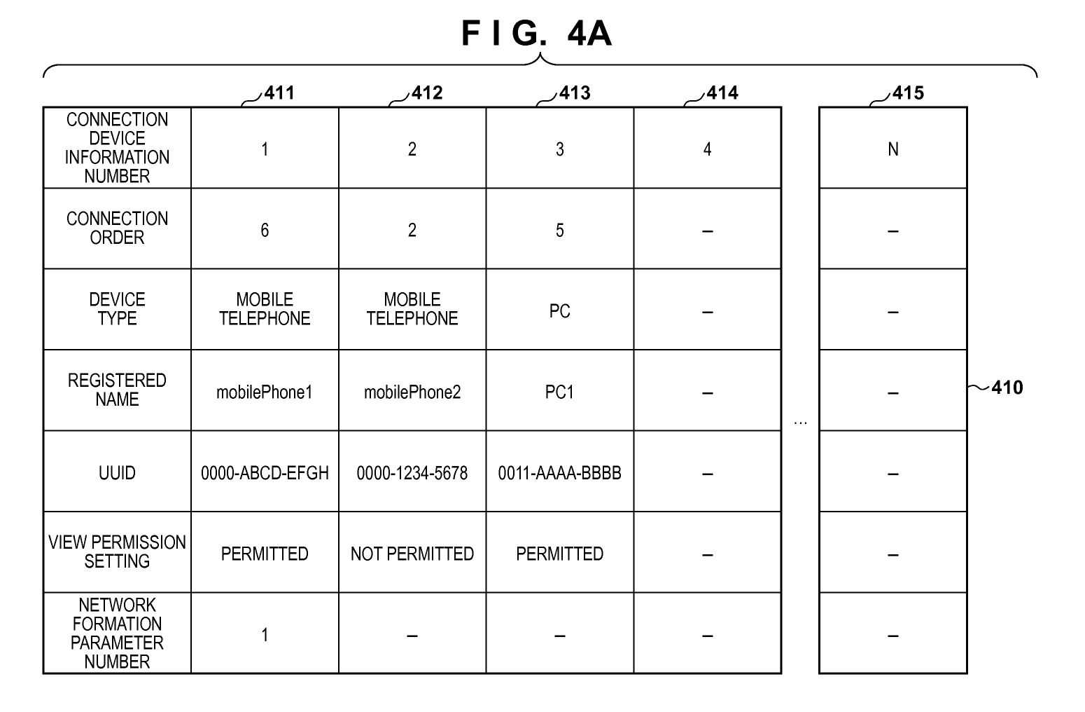

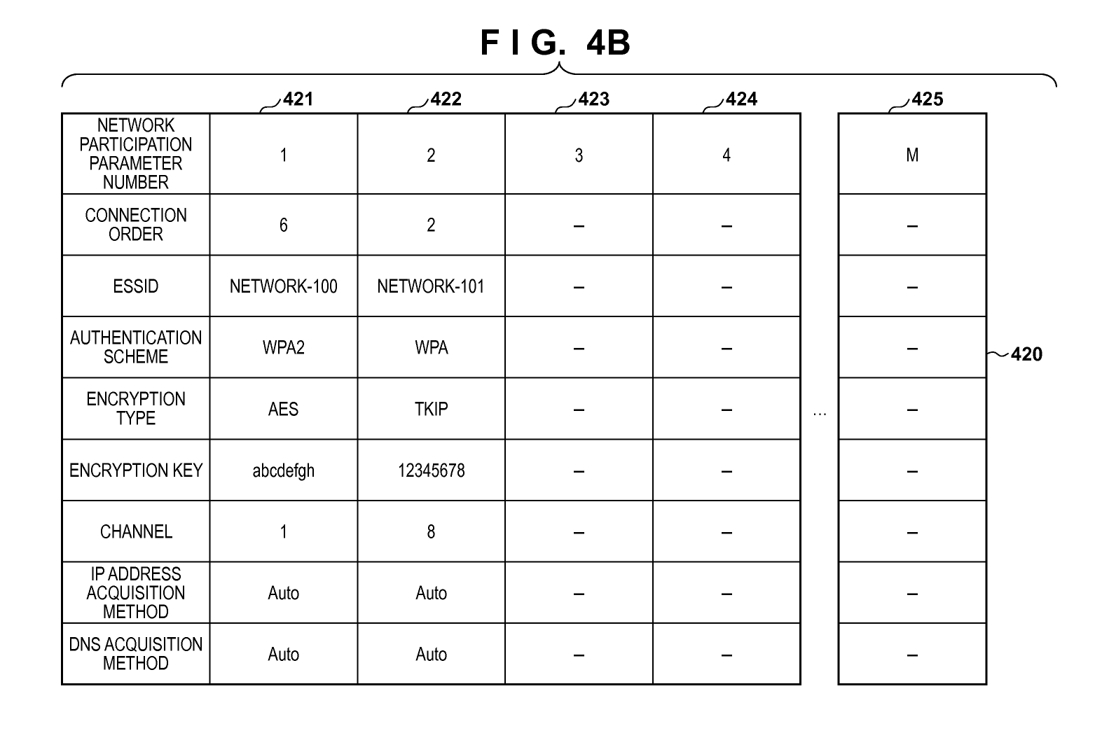

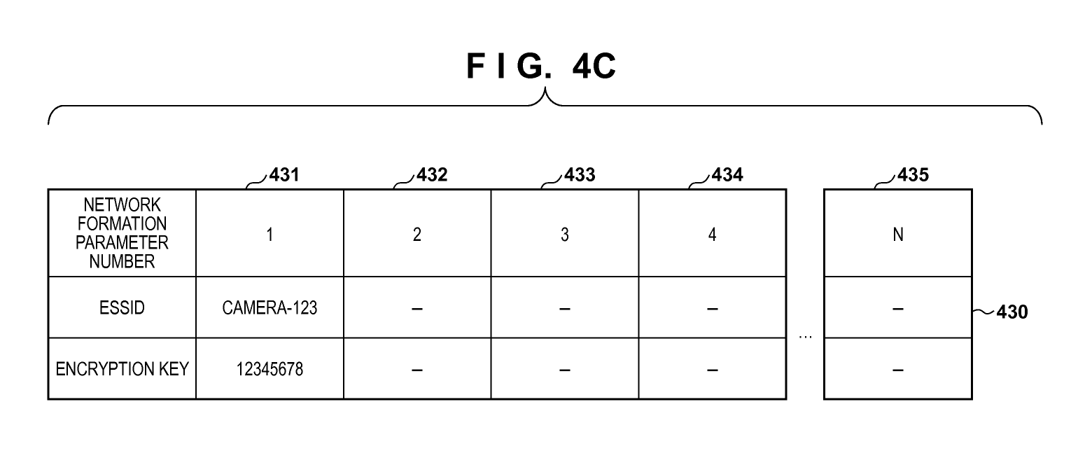

When the encryption setting is enabled, the control unit 101 encrypts communication in the formed wireless LAN network. Encryption is applied in accordance with an encryption key (encryption information), which will be described later with reference to FIGS. 4A to 4C.

<Data Structure of Connection History>

With reference to FIGS. 4A to 4C, the following describes databases retained by the digital camera 100 according to the present embodiment.

In order for the digital camera 100 to connect to a partner device (communication partner apparatus), it first joins in a network (including a network that it has formed while serving as a simple AP), and then establishes connection with the partner device. In the present embodiment, information of a network and information of a partner device to connect to are managed in different databases. Connection device information 410, network participation parameters 420, and network formation parameters 430 are recorded in the databases retained by the digital camera 100 according to the present embodiment.

The connection device information 410 is information for managing partner devices to which the digital camera 100 has connected via a network. It should be noted that the connection device information 410 is one example of history information stored in a first storage unit. A “connection device information number” assigned to each connection device information, a “connection order”, a “device type”, a “registered name”, a “UUID”, a “view permission setting”, and a “network formation parameter number” are recorded in connection device information 410. Here, the “connection order” is the order in which the digital camera 100 has connected to connection devices stored in the connection device information 410 in the past, and the larger the number thereof, the more recent the connection. The “registered name” is a name of a connection device that can be set by the user, and it can be freely changed by the user in such a manner that the connection device is distinguishable. It should be noted that the “device type”, “registered name”, “UUID”, and the like need not necessarily be discrete pieces of information, and these pieces of information may be identifiable with, for example, one ID obtained by combining a type, a name, and a unique character string. The “network formation parameter number” indicates which one of the network formation parameters 430 was used to form a network. N pieces of connection device information 410 can be stored, and in order to store more, it is necessary to delete connection device information 410 already stored. It should be noted that connection device information 410 may be deleted through an operation by the user of the digital camera 100, and when this information is to be newly stored in a state where N pieces of this information are stored, connection device information 410 with a “connection order” of the smallest number may be deleted by referring to the “connection orders”.

The network participation parameters 420 are information for managing networks in which the digital camera 100 has joined and which have been formed by an external AP and the like. It should be noted that the network participation parameters 420 are one example of history information stored in a second storage unit. A “network participation parameter number” assigned to each network participation parameter, a “connection order”, an “ESSID”, an “authentication scheme”, and an “encryption type” are stored in a network participation parameter 420. An “encryption key”, a “channel”, an “IP address acquisition method”, and a “DNS acquisition method” are also stored therein. Here, the “connection order” is the order in which the digital camera 100 has joined in wireless networks stored in the network participation parameters 420 in the past, and the larger the number thereof, the more recent the participation. M network participation parameters 420 can be stored, and in order to store more, it is necessary to delete a network participation parameter 420 already stored. It should be noted that a network participation parameter 420 may be deleted through an operation by the user of the digital camera 100. Alternatively, when this parameter is to be newly stored in a state where M parameters are stored, a network participation parameter 420 with a “connection order” of the smallest number may be deleted by referring to the “connection orders”. It should be noted that if the digital camera 100 serving as a simple AP has formed a network, information of the network is managed in the below-described network formation parameters 430 as information that can be distinguished from the network participation parameters 420.

The network formation parameters 430 are intended to manage information of networks formed by the digital camera 100 serving as a simple AP. A “network formation parameter number” assigned to each network formation parameter, an “ESSID”, and an “encryption key” are stored in a network formation parameter 430. An authentication scheme, an encryption type, a channel, an IP address acquisition method, a DNS acquisition method, and the like may be stored in a network formation parameter 430, but items that are common to all networks formed by the digital camera 100 need not necessarily be stored. It should be noted that, as stated earlier, in the present embodiment, the digital camera 100 stores a parameter (e.g., ESSID) for a case in which the encryption setting is enabled, and converts the stored parameter into a parameter for a case in which the encryption setting is disabled as necessary. Also, as with the connection device information 410, N network formation parameters 430 can be stored. When connection device information 410 is deleted, an associated network formation parameter 430 is deleted so as to avoid a situation in which the number of stored network formation parameters 430 is larger than N.

The control unit 101 may deploy the databases retained by the digital camera 100 from the non-volatile memory 103 to the working memory 104 for use. The following description will be given under the assumption that the database retained by the digital camera 100 has been deployed to the working memory 104.

<Device Registration Processing>

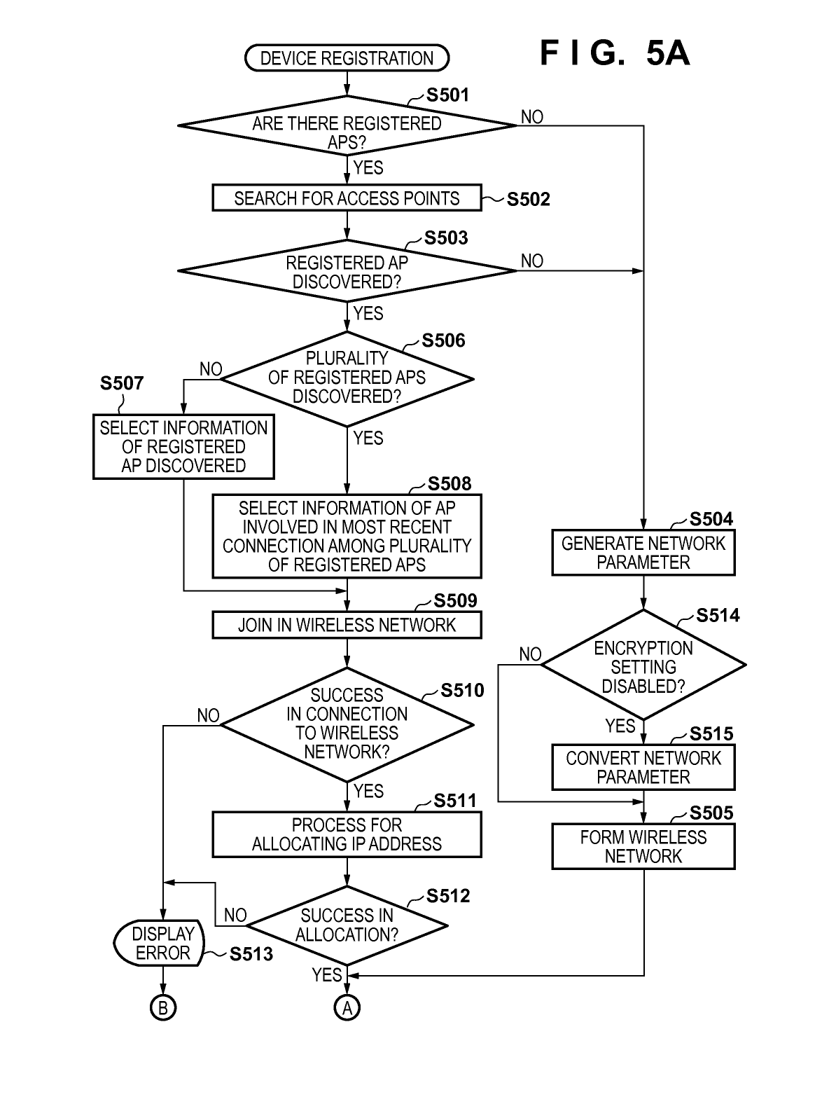

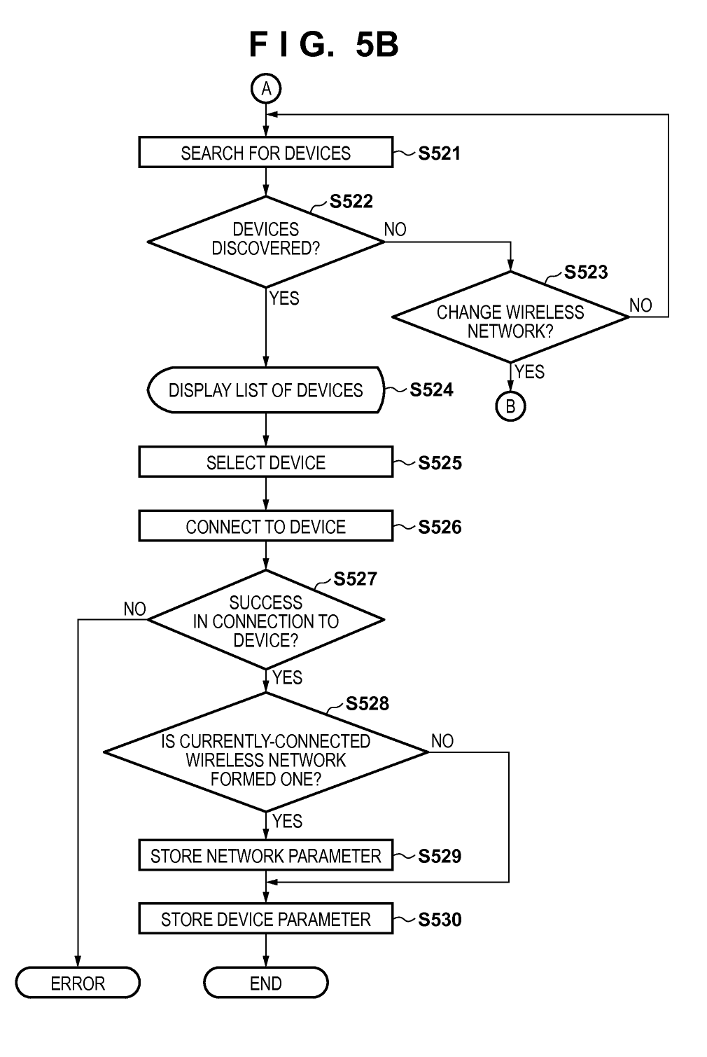

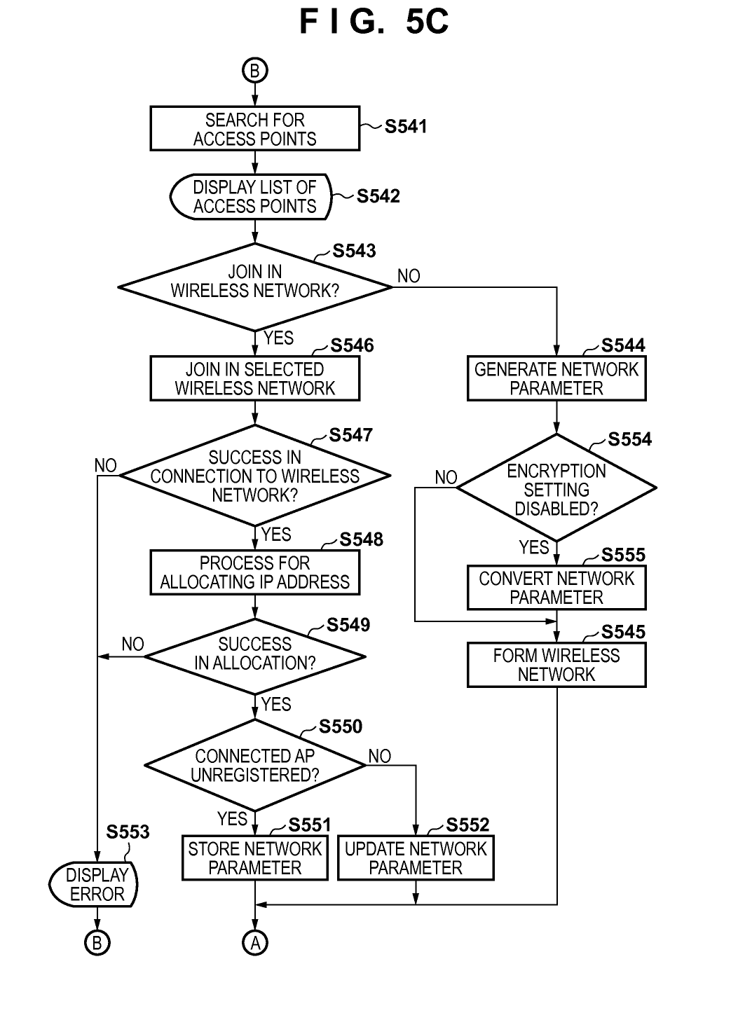

With reference to FIGS. 5A to 5C, the following describes processing of the digital camera 100 according to the present embodiment for a case in which the digital camera 100 communicates with a communication apparatus, such as the mobile telephone 200, for the first time. The processing described below is realized by the control unit 101 of the digital camera 100 controlling the components of the digital camera 100 in accordance with an input signal and a program. It should be noted that the same goes for other flowcharts showing processing of the digital camera 100, unless particularly stated otherwise. The present processing is started in response to an instruction for connecting to another apparatus issued by the user of the digital camera 100 through a menu operation and the like.

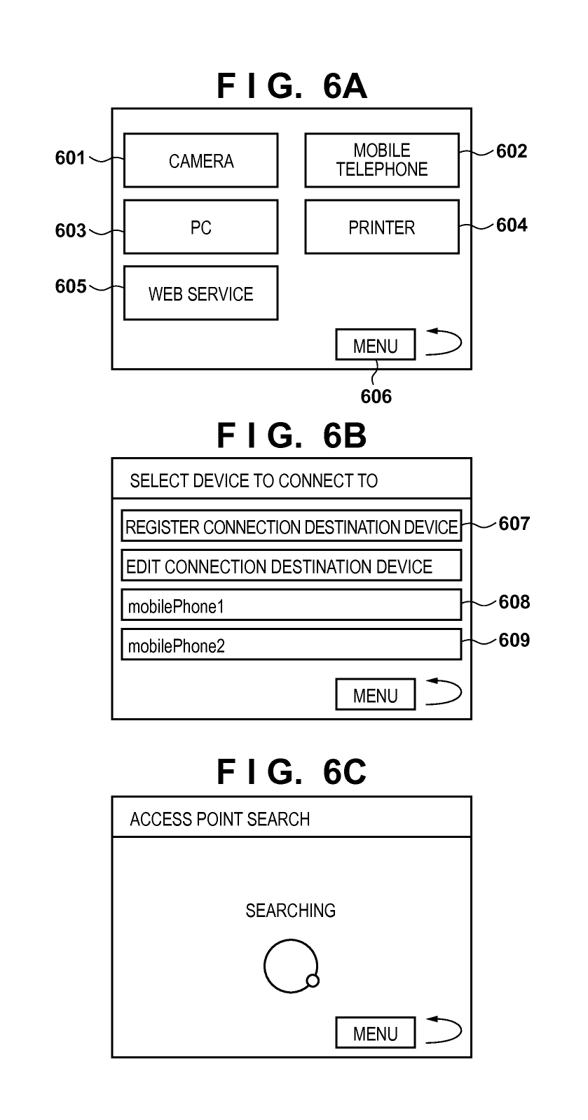

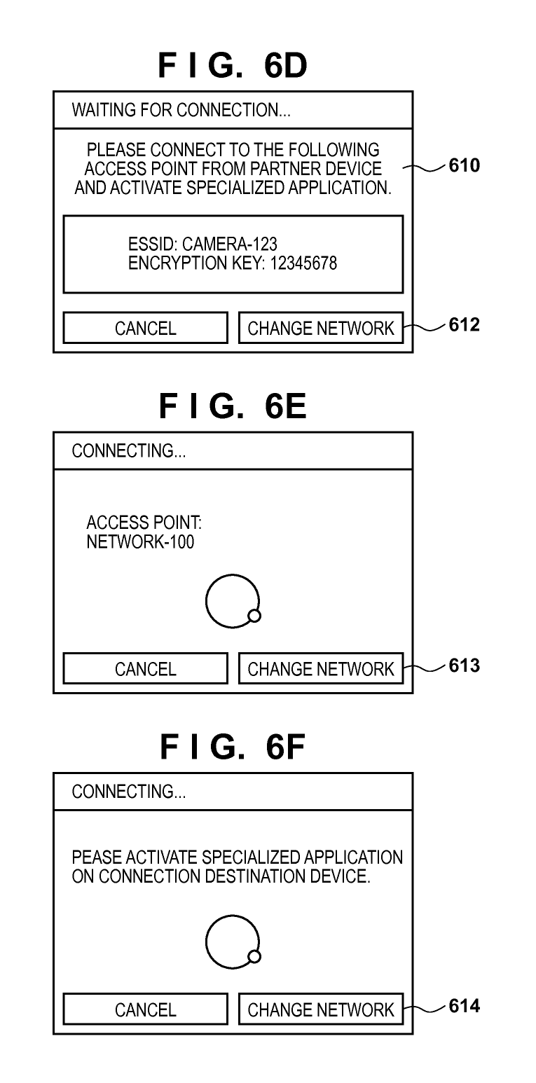

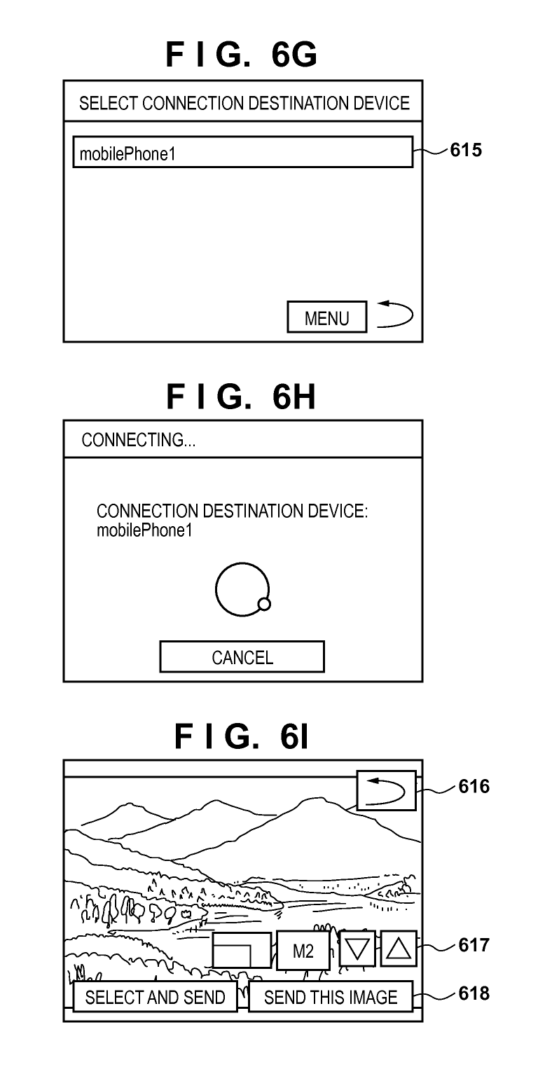

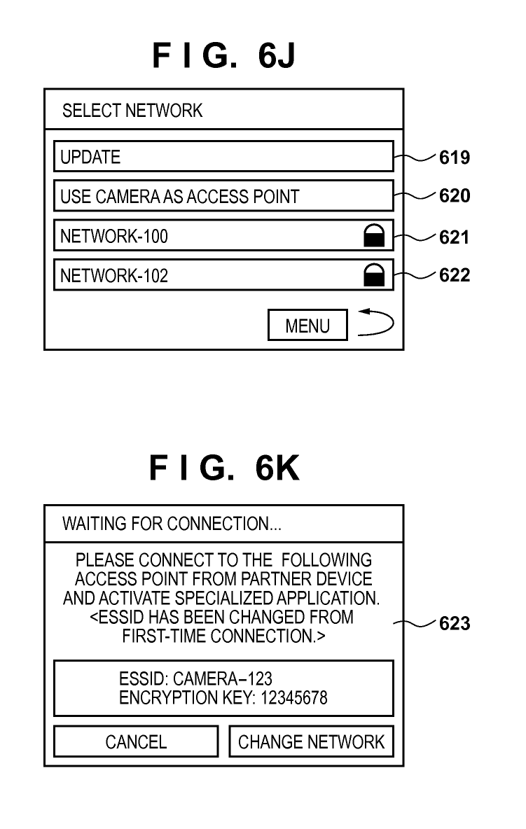

FIG. 6A shows an example of a UI screen that is displayed on the display unit 106 at the time of starting the connection to a connection device. The user of the digital camera 100 selects, for example, a camera 601, a mobile telephone 602, a PC 603, a printer 604, and a web service 605 as a device type of the connection device. Selection of MENU 606 results in return to an immediately previous screen. In the present embodiment, a description is given of a case in which the mobile telephone 602 is selected.

FIG. 6B shows an example of a UI screen that is displayed on the display unit 106 at the time of selecting either device registration processing or connection processing for the second time onward when the user of the digital camera 100 has selected the device type targeted for connection. The user of the digital camera 100 either selects registration of a connection destination device, 607, and registers a connection device of the foregoing device type, or selects connection devices 608, 609 that have already been registered and executes connection processing for the second time onward.

First, with reference to FIG. 5A, a description is given of processing of the digital camera 100 at the time of execution of device registration processing (network participation/formation) for a case in which “register connection destination device” has been selected.

Referring to FIG. 5A, in step S501, the control unit 101 determines whether or not the network participation parameters 420 are stored. If the control unit 101 determines that the network participation parameters 420 are stored, it proceeds to step S502 and executes an AP search process to join in a wireless network. On the other hand, if the control unit 101 determines that the network participation parameters 420 are not stored, it proceeds to step S504 and executes a wireless network formation process.

In step S502, the control unit 101 searches for APs existing nearby by controlling the connection unit 111. FIG. 6C shows an example of a screen that is displayed on the display unit 106 during the AP search.

In step S503, the control unit 101 determines whether or not an AP stored in the network participation parameters 420, that is to say, a registered AP has been discovered in the AP search of step S502. If the control unit 101 determines that a registered AP has been discovered in the AP search, it proceeds to step S506. If the control unit 101 determines that a registered AP has not been discovered in the AP search, it proceeds to step S504 and executes a wireless network formation process while serving as a simple AP. It should be noted that, in the present embodiment, whether or not an AP stored in the network participation parameters 420 has been discovered in the AP search of step S502 is determined by comparing ESSIDs; however, this determination may be made using other identifiers, such as BSSIDs.

Also, the reason why processing proceeds to step S504 if the network participation parameters 420 are not stored in step S501 is because a registered AP cannot be discovered in step S503 even if the AP search is conducted in step S502. Therefore, the search process of step S502 is skipped for the purpose of shortening a time period until the establishment of connection. Another reason is that, when the network participation parameters 420 are not stored, participation in a network requires a network selection, input of a parameter, and the like, thus complicating an operation on the digital camera 100. Therefore, network formation by a simple AP, in which the trouble of inputting a parameter is alleviated, is prioritized.

In step S504, the control unit 101 generates an ESSID, an authentication scheme, an encryption type, an encryption key, and a channel necessary for forming a wireless LAN network. In the case of new registration processing, at least one of the ESSID, encryption key, authentication scheme, encryption type, and channel generated by the digital camera 100 according to the present embodiment differs each time. In the present embodiment, generated ESSID and encryption key differ each time. It should be noted that, in the present embodiment, the control unit 101 does not register the generated network parameter as a network formation parameter 430 at the timing of step S504. The generated network parameter is registered and stored as a network formation parameter 430 upon establishment of connection with the connection device, which will be described later.

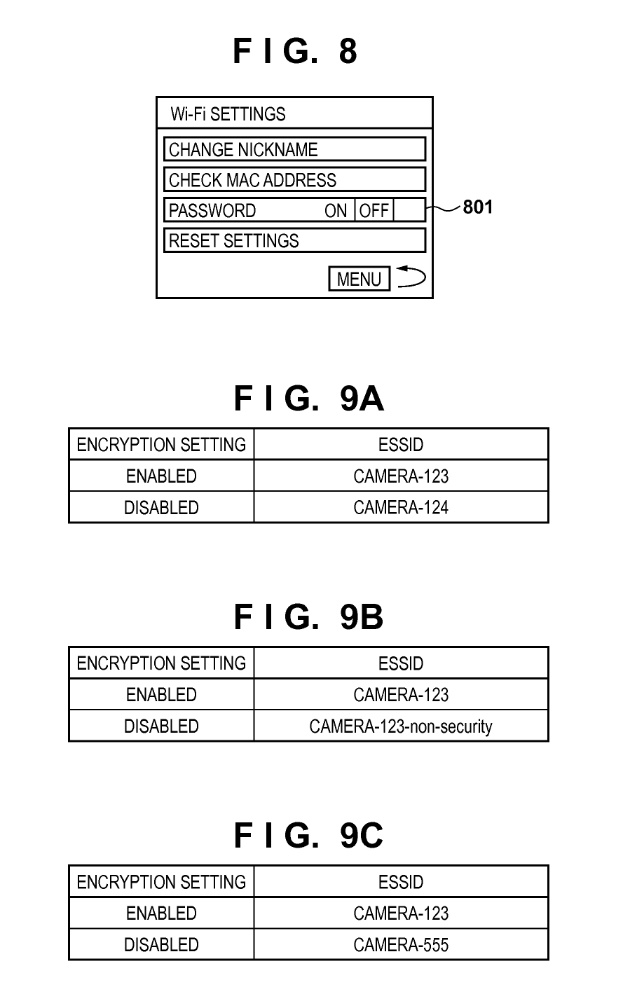

In step S514, the control unit 101 judges whether or not the encryption setting of the wireless LAN network to be formed is disabled. FIG. 8 shows an example of a screen that is displayed on the display unit 106 at the time of configuration of the encryption setting of the wireless LAN network to be formed. On the screen shown in FIG. 8, “on” and “off” of a password 801 can be selected; in the case of “on”, the encryption setting of the wireless LAN network to be formed is enabled, whereas in the case of “off”, the encryption setting of the wireless LAN network to be formed is disabled. It is desirable that this setting be configured ahead of time. If the control unit 101 judges that the encryption setting of the wireless LAN network to be formed is disabled, it proceeds to step S515 and executes a process for converting the generated network parameter. On the other hand, if the control unit 101 judges that the encryption setting of the wireless LAN network to be formed is enabled, it proceeds to step S505 and executes a wireless LAN network formation process.

In step S515, the control unit 101 converts the network parameter generated in step S504. It should be noted that, in the present embodiment, the control unit 101 generates a network parameter for a case in which the encryption setting is enabled, and converts the network parameter if it judges in step S514 that the encryption setting of the wireless LAN network to be formed is disabled. As a result of this conversion, among the ESSID, authentication scheme, encryption type, encryption key, and channel generated in step S504, the authentication scheme is converted into “OPEN”, the encryption type is converted into “none”, and the encryption key is converted into “none”. In the present embodiment, the control unit 101 changes the ESSID as well. FIGS. 9A to 9C show examples of conversion of the ESSID.

FIG. 9A shows “CAMERA-124” obtained by deleting the last one character of an ESSID “CAMERA-123” for the case in which the encryption setting is enabled, and then adding one character associated with the deleted character. FIG. 9B shows “CAMERA-123-non-security” obtained by adding, to the end, a character string that indicates a disabled state of the encryption setting. While the network parameter generated in step S504 is converted in the present embodiment, the control unit 101 may simultaneously generate an ESSID for the case in which the encryption setting is enabled when generating the network parameter in step S504. FIG. 9C shows an example of a pre-generated ESSID for the case in which the encryption setting is disabled; there is no association between this ESSID and the ESSID for the case in which the encryption setting is enabled. Also, the ESSID (network identifier) may include a common part (e.g., “CAMERA-XXX-”) that is unique to the digital camera 100, whether the encryption setting is enabled or disabled.

In step S505, the control unit 101 forms a wireless LAN network using the network parameter generated in step S504 or the network parameter converted in step S515. The control unit 101 also displays at least the ESSID on the display unit 106 as information that is necessary for an external apparatus to join in the network. FIG. 6D shows an example of a screen that is displayed on the display unit 106 while waiting for the connection. On the screen shown in FIG. 6D, the ESSID and encryption key are decided to be “CAMERA-123” and “12345678”, respectively, as indicated by a dialog 610. By checking this display, a user of the external apparatus can easily join in the network formed by the digital camera 100.

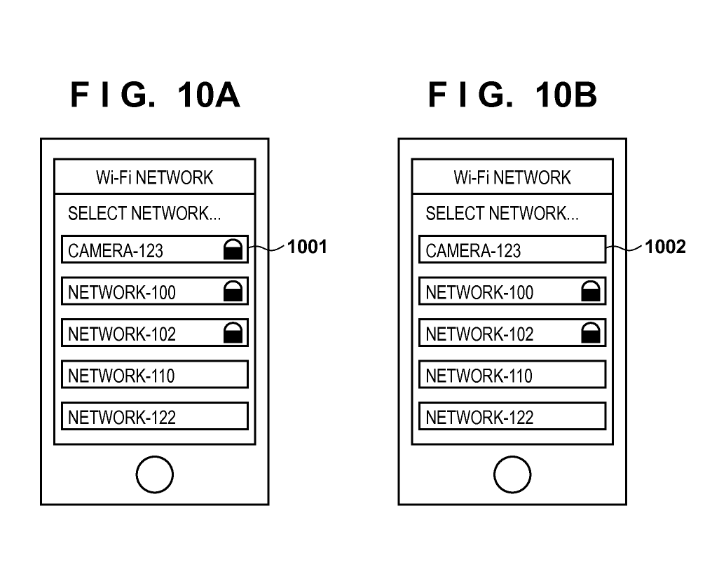

FIGS. 10A and 10B show examples of screens that are displayed on the external apparatus (in the present embodiment, the mobile telephone 200). When the encryption setting of the network formed by the digital camera 100 is enabled, the external apparatus displays reference numeral 1001 shown in FIG. 10A. Reference numeral 1001 represents a “key icon” indicating that the encryption setting is enabled because the encryption setting for the ESSID “CAMERA-123” is enabled. On the other hand, when the encryption setting of the network formed by the digital camera 100 is disabled, the external apparatus displays reference numeral 1002 shown in FIG. 10B. The “key icon” indicating that the encryption setting is enabled is not displayed in a position pointed by reference numeral 1002 because the encryption setting for the ESSID “CAMERA-124” is disabled.

In step S505, the control unit 101 further allocates an IP address and sets a subnet to allow for communication with another device, and then proceeds to step S521.

A description is now given of a case in which processing proceeds from step S503 to step S506.

In step S506, the control unit 101 determines whether or not a plurality of APs stored in the network participation parameters 420 have been discovered in the AP search of step S502. If the control unit 101 determines that a plurality of APs have been discovered in the AP search, it proceeds to step S508. If the control unit 101 determines that a plurality of APs have not been discovered in the AP search, it proceeds to step S507.

In step S507, the control unit 101 selects the AP stored in the network participation parameters 420 from among APs discovered in the AP search of step S502, and proceeds to step S509.

In step S508, the control unit 101 selects an AP that is stored in the network participation parameters 420 and was involved in the recent participation from among APs discovered in the AP search of step S502, and proceeds to step S509. The control unit 101 can select an AP involved in the most recent participation by referring to information of the “connection orders” in the network participation parameters 420 and selecting a “connection order” of the largest value. For example, assume that three APs, NETWORK-100, NETWORK-101 and NETWORK-102 are searched for in the AP search of step S502 in a state where the network participation parameters 420 shown in FIG. 4B are stored. In this case, NETWORK-100 stored in 421 and NETWORK-101 stored in 422 are stored in the network participation parameters 420. In the network participation parameters 420 corresponding thereto, a “connection order” of NETWORK-100 is “6”, whereas a “connection order” of NETWORK-101 is “2”, and therefore NETWORK-100 421 with a large value is selected as an AP involved in the recent participation.

In step S509, the control unit 101 refers to the network participation parameters 420 and joins in a wireless LAN network of the AP selected in step S507 or step S508. FIG. 6E shows an example of a screen that is displayed on the display unit 106 during a process for participating in the wireless LAN network.

In step S510, the control unit 101 determines whether or not it has succeeded in connecting to the wireless LAN network. If the control unit 101 determines that it has succeeded in the connection, it proceeds to step S511. If the control unit 101 determines that it has failed in the connection, it proceeds to step S513 and displays error.

In step S511, the control unit 101 allocates an IP address and sets a subnet by referring to an IP address acquisition method and a DNS acquisition method in the network participation parameters 420, and proceeds to step S512.

In step S512, the control unit 101 determines whether or not it has succeeded in allocating the IP address. If the control unit 101 determines that it has succeeded allocating the IP address, it proceeds to step S521 and executes a device search process. If the control unit 101 determines that it has failed in the allocation of the IP address, it proceeds to step S513 and displays error.

In step S513, the control unit 101 displays failure in the connection to the wireless LAN network or failure in the allocation of the IP address on the display unit 106. If the control unit 101 is notified of confirmation of the substance of the error by the user of the digital camera 100, it proceeds to step S541.

This concludes the description of processing in which the digital camera 100 joins in a network.

With reference to FIG. 5B, the following describes processing of the digital camera 100 at the time of execution of device registration processing (connection to a connection device).

Referring to FIG. 5B, in step S521, the control unit 101 searches for connectable devices within the same network. The control unit 101 conducts the search using an SSDP (Simple Service Discovery Protocol), an mDNS (Multicast Domain Name Service), and the like, and detects a service notification from the mobile telephone 200. It should be noted that, in the present embodiment, the user also performs a predetermined operation on the mobile telephone 200 at this time, and causes the mobile telephone 200 to shift to a state in which it can be searched for by the digital camera 100. In the present embodiment, the mobile telephone 200 shifts to a state in which it can be searched for by the digital camera 100 by way of activation of a predetermined communication application. FIGS. 6D and 6F show examples of screens that are displayed on the display unit 106 while searching for devices. FIG. 6D shows an example of a screen for a case in which a wireless LAN network has been formed using the simple AP function of the digital camera 100. As indicated by 610, the control unit 101 displays, on the display unit 106, the ESSID and encryption key of the formed wireless network, as well as a message for suggesting the user to activate an application of the mobile telephone 200. FIG. 6F shows an example of a screen for the case of participation in a wireless LAN network formed by an external AP, and follows FIG. 6E. The control unit 101 displays, on the display unit 106, a message for suggesting the user to activate the application of the mobile telephone 200. Once the user activates the application of the mobile telephone 200 in response, the mobile telephone 200 issues a service notification to the connected network and thus allows the digital camera 100 to search for the mobile telephone 200.

In step S522, the control unit 101 determines whether or not it has discovered connectable devices. If the control unit 101 determines that it has discovered connectable devices, it proceeds to step S524 and displays a list of discovered devices. If the control unit 101 determines that it has not discovered any connectable device, it proceeds to step S523.

In step S523, the control unit 101 determines whether or not the user of the digital camera 100 has issued an instruction for changing a wireless network. If the control unit 101 determines that the instruction for changing a wireless network has been issued, it either dissolves the wireless LAN network that is currently formed or withdraws from the network involved in the current participation, and then proceeds to step S541. If the control unit 101 determines that the instruction for changing a wireless network has not been issued, it proceeds to step S521. For example, referring to FIG. 6D showing the example of the screen for the case in which the wireless LAN network has been formed, if a network change 612 is selected, it is determined that the instruction for changing a wireless network has been issued, the wireless LAN network that is currently formed is dissolved, and processing proceeds to step S541. Referring to FIG. 6F showing the example of the screen for the case of participation in the wireless LAN network, if a network change 614 is selected, it is determined that the instruction for changing a wireless network has been issued, withdrawal from the wireless LAN network involved in the current participation is carried out, and processing proceeds to step S541. Referring to FIG. 6E showing the example of the screen that is displayed during the process for participating in the wireless LAN network, if a network change 613 is selected, the process for participating in the wireless LAN network is interrupted, and processing proceeds to step S541.

In step S524, the control unit 101 displays a list of device names included in service notifications on the display unit 106. FIG. 6G shows an example of a screen that is displayed on the display unit 106 as a list of connectable devices. In FIG. 6G, “mobilePhone1” has been detected as a connectable device. In the present step, the UUIDs and device names included in the service notifications are also stored, in association, into the working memory 104.

While the present embodiment adopts a configuration in which a service notification includes a device name and a UUID, the present embodiment may adopt a configuration in which the digital camera 100 that has received a service notification inquires the mobile telephone 200 about a device name and a UUID. Also, when a connection device corresponding to a UUID included in a service notification has already been stored in the connection device information 410, a registered name stored in the connection device information 410 may be displayed on the display unit 106 in place of a device name included in the service notification.

In step S525, the control unit 101 makes the user of the digital camera 100 select one of the device names that were displayed in the list in step S524. In the case of FIG. 6G showing the example of the screen of the list displayed in step S524, a connectable device 615 can be selected. Also, the search for connection devices is continued during the present step, and if connectable devices are newly detected, the control unit 101 displays a list of device names included in service notifications on the display unit 106.

In step S526, the control unit 101 transmits a connection request to the mobile telephone 200 using a UUID of the device selected in step S525, starts a process for establishing the connection with the selected device, and proceeds to step S527. While the connection is implemented using a UUID of a connection device in the present embodiment, the connection may be implemented by identifying an IP address and a port number from the UUID. Also, an IP address may be obtained at the time of the search. FIG. 6H shows an example of a screen that is displayed on the display unit 106 as a connection request destination device. Referring to the screen shown in FIG. 6H, the connection request is transmitted to “mobilePhone1”.

In step S527, the control unit 101 determines whether or not it has succeeded in establishing connection with the selected device. If the control unit 101 determines that it has succeeded in establishing the connection, it proceeds to step S528. If the control unit 101 determines that it has failed in the establishment of the connection, it displays error on the display unit 106 and ends the device registration processing. FIG. 6I shows an example of a screen that is displayed on the display unit 106 upon establishment of the connection. A disconnection button 616, resize selection buttons 617, an image transmission button 618, and the like are displayed on the screen shown in FIG. 6I; if the disconnection button 616 is selected, the established connection with the device is disconnected. Selection of the resize selection buttons 617 allows for a change in the resize setting, e.g., a change to “no resizing”, “size M”, and “size S”. If the image transmission button 618 is selected, an image is resized to a size selected through the resize setting and then transmitted to the device with which the connection is established.

In step S528, the control unit 101 determines whether or not the currently-connected wireless LAN network is a network that the digital camera 100 formed using the simple AP function of its own. If the control unit 101 determines that the currently-connected wireless LAN network is a network that the digital camera 100 formed by itself, it proceeds to step S529. If the control unit 101 determines that the currently-connected wireless LAN network is not a network that the digital camera 100 formed by itself, it proceeds to step S530.

In step S529, the control unit 101 stores a parameter of the network that the digital camera 100 formed by itself as a network formation parameter 430. For example, assume a case in which the digital camera 100 formed a network in a state where no network formation parameter is stored, and an ESSID and an encryption key of the formed network are “CAMERA-123” and “12345678”, respectively. In this case, information of a network formation parameter 430 in a column 431 shown in FIG. 4C is stored. As stated earlier, in the present embodiment, the control unit 101 stores a parameter for a case in which the encryption setting is enabled. Therefore, when the encryption setting is disabled, the control unit 101 stores a network parameter prior to the network parameter conversion in step S515 shown in FIG. 5A as a network formation parameter 430.

It should be noted that a network parameter is stored only if it is determined that the currently-connected wireless LAN network is a network that the digital camera 100 formed by itself for the following reason. One network formation parameter is stored in association with one connection device; in this way, as will be described later, a network formation parameter becomes usable in connection for the second time onward. Therefore, a parameter is not stored immediately after formation of a network, but is stored after a connection device to be associated has been decided on. Also, the reason why a network parameter is not stored if it is determined that the currently-connected wireless LAN network is not a network that the digital camera 100 formed by itself is because it is stored at the time of network change processing, which will be described later.

In step S530, the control unit 101 stores information of the connection device into the connection device information 410. For example, in a state where connection device information numbers 2 and 3 have already been registered, if a device with which the connection has been established is “mobilePhone1”, a column 411 with a connection device information number 1 shown in FIG. 4A serves as the information of the connection device. At this time, the connection device information number needs to be a number other than those of the connection device information already stored. A connection order needs to be set such that it has a larger value than the connection orders of the connection device information already stored. The UUID that was stored into the working memory in step S524 may be stored, or an inquiry may be made to the mobile telephone 200 about a UUID. A view permission selected by the user of the digital camera 100 may be stored, or one of permission and non-permission may be stored as a default state of a view permission in such a manner that it can be changed later. With regard to a network formation parameter number, if it is determined in step S528 that the currently-connected wireless LAN network is a network that the digital camera 100 formed by itself, the network formation parameter number stored in step S529 is stored. If it is determined in step S528 that the currently-connected wireless LAN network is not a network that the digital camera 100 formed by itself, nothing is stored.

With reference to FIG. 5C, the following describes processing of the digital camera 100 at the time of execution of device registration processing (network change).

Referring to FIG. 5C, in step S541, the control unit 101 searches for APs existing nearby and proceeds to step S542.

In step S542, the control unit 101 displays, on the display unit 106, a list of ESSIDs included in beacon signals that have been detected as a result of the scan in step S541. FIG. 6J shows an example of a screen that is displayed on the display unit 106 as a result of the AP search. On the screen shown in FIG. 6J, ESSIDs “NETWORK-100” and “NETWORK-102” have been detected. If an update 619 is selected, APs existing nearby are searched for again, and a screen similar to the one shown in FIG. 6J is displayed. While only two nearby APs are displayed in the present embodiment, if a plurality of nearby APs are discovered, the plurality of nearby APs may be displayed on a scrollable screen. At this time, by referring to the “connection orders” of the network participation parameters 420, APs that were involved in participation in the past may be sorted in descending order of recent participation. Also, these APs may be sorted in descending order of radio wave intensity.

In step S543, the control unit 101 determines whether or not to join in a wireless LAN network. Referring to FIG. 6J, if detected APs 621, 622 are selected, the control unit 101 determines that it will join in a wireless LAN network, proceeds to step S546, and executes a process for participating in a selected wireless LAN network. If 620 for instructing formation of a wireless LAN network is selected, the control unit 101 determines that it will not join in a wireless LAN network, and proceeds to step S544.

Processes of steps S544, S554, S555 and S545 are similar to the processes of steps S504, S514, S515 and S505, and therefore a description thereof is omitted.

In step S546, the control unit 101 joins in a wireless LAN network of an AP selected in step S543, and proceeds to step S547. At this time, if the selected AP is stored in the network participation parameters 420, participation in the wireless LAN network may be carried out without having an encryption key and the like input. Alternatively, an encryption key stored as an initial value for an encryption key input screen may be input. Also, with regard to an IP address acquisition method and a DNS acquisition method, stored methods may be used without having them selected, or methods may be selected by the user of the digital camera 100 again. If the selected AP is not stored in the network participation parameters 420, a necessary parameter may be input by the user of the digital camera 100. An IP address acquisition method and a DNS acquisition method may be input by the user of the digital camera 100, or may be set to Auto in a default state.

Processes of step S547 to step S549 are similar to the processes of step S510 to step S512, and therefore a description thereof is omitted. In step S547, if the control unit 101 determines that it has failed in connection to the wireless LAN network, it proceeds to step S553 and displays error on the display unit 106. In step S549, if the control unit 101 determines that it has succeeded in allocating an IP address, it proceeds to step S550. If the control unit 101 determines that it has failed in the allocation of the IP address, it proceeds to step S553 and displays error on the display unit 106.

In step S550, the control unit 101 refers to the network participation parameters 420 and determines whether or not the wireless LAN network involved in the current participation has already been stored. If the control unit 101 determines that the wireless LAN network has already been stored, it proceeds to step S552 and updates a network parameter. If the control unit 101 determines that the wireless LAN network has not been stored, it proceeds to step S551 and newly stores a network parameter.

In step S551, the control unit 101 stores a parameter of the wireless LAN network involved in the current participation as a network participation parameter 420, and proceeds to step S521. For example, assume a case in which a network NETWORK-102 has been selected from the list of APs displayed in step S542. In this case, in a column 423 with a network participation parameter number 3, “NETWORK-102” is stored under an ESSID, and appropriate values are stored under an authentication scheme, an encryption type, an encryption key, a channel, an IP address acquisition method, and a DNS acquisition method. Also, as a connection order needs to have the largest value, “7” is stored thereas.

In step S552, the control unit 101 updates the network participation parameters 420 using the parameter of the wireless LAN network involved in the current participation, and proceeds to step S521. For example, if a network NETWORK-101 is selected from the list of APs displayed in step S542, a connection order of a column 422 with a network participation parameter number 2 is updated to “7” as it needs to have the largest value.

A process of step S553 is similar to the process of step S513, and therefore a description thereof is omitted. After the error is displayed in step S553, if the control unit 101 is notified of confirmation of the substance of the error by the user of the digital camera 100, it proceeds to step S541.

<Connection for Second Time Onward>

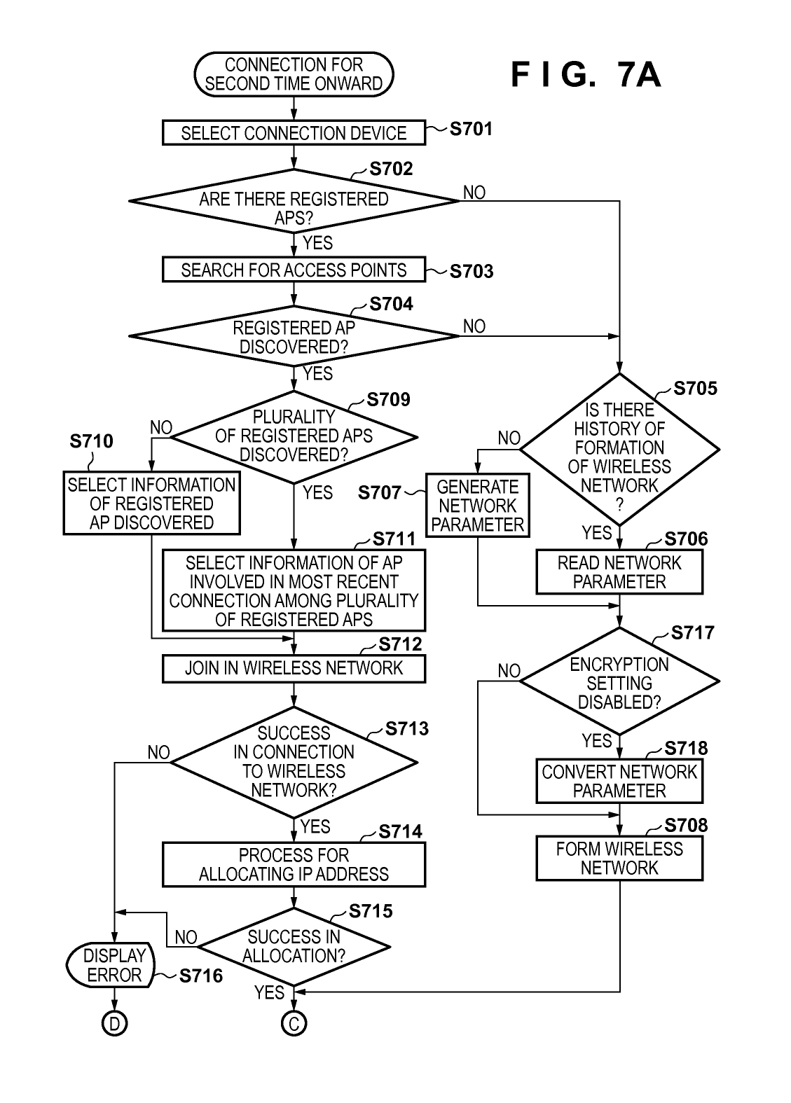

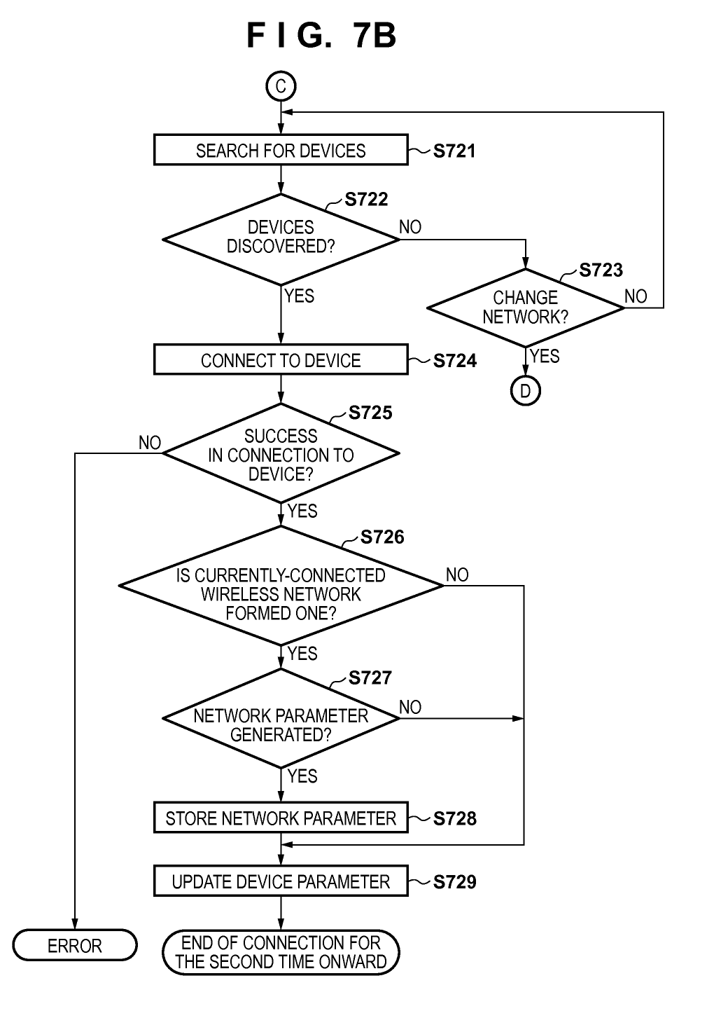

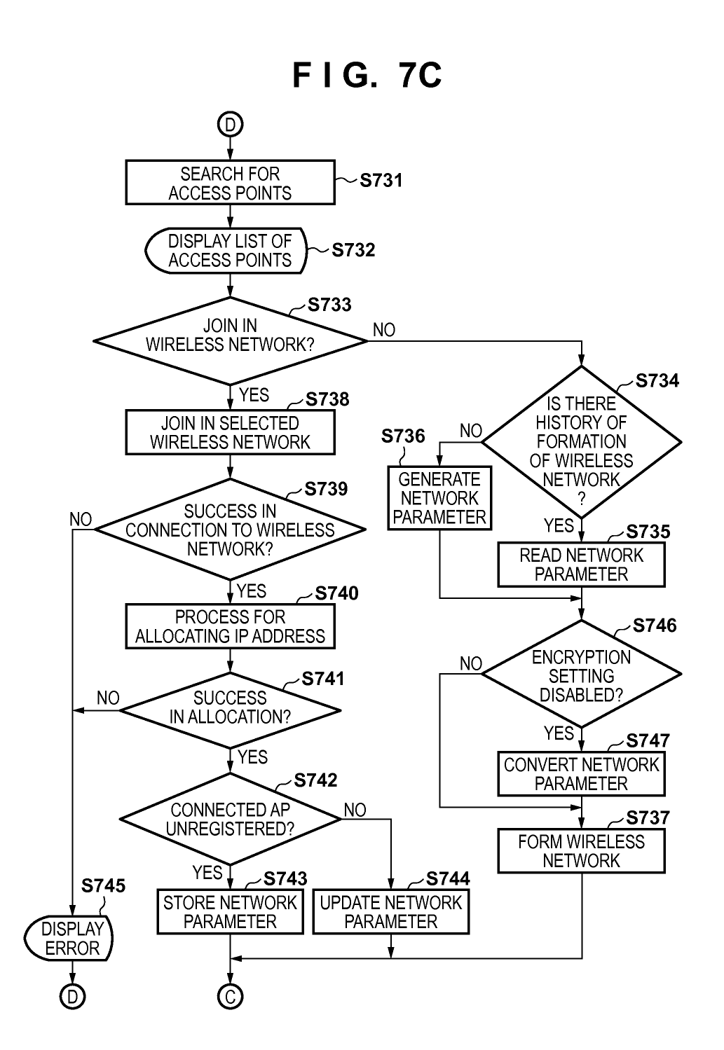

With reference to FIGS. 7A to 7C, the following describes processing of the digital camera 100 at the time of connecting to a connection device, such as the mobile telephone 200, for the second time onward.

First, with reference to FIG. 7A, a description is given of processing of the digital camera 100 at the time of execution of connection processing (network participation/formation) for the second time onward.

In step S701, the control unit 101 accepts a selection of a connection device from the user of the digital camera 100. As stated earlier, if the connection devices 608, 609 shown in FIG. 6B, which have already been registered, are selected, connection processing for the second time onward is executed. Here, a list of devices stored in the connection device information 410 is displayed as the connection devices that have already been registered. For example, given the device information shown in FIG. 4A, the connection devices that have already been registered are “mobilePhone1” 411, “mobilePhone2” 412, and “PC1” 413. Here, as the mobile telephone 602 is selected in FIG. 6A, only “mobilePhone1” 411 and “mobilePhone2” 412, whose device types are the mobile telephone, are displayed as the connection devices that have already been registered.

Processes of step S702 to step S704 are similar to the processes of step S501 to step S503 shown in FIG. 5A, and are therefore omitted from the present description.

In step S702, if the control unit 101 determines that the network participation parameters 420 are not stored, it proceeds to step S705. On the other hand, if the control unit 101 proceeds to step S704, it determines whether or not an AP stored in the network participation parameters 420 has been discovered in the AP search of step S703, and proceeds to step S709 if it determines that a stored AP has been discovered in the AP search. If the control unit 101 determines that a stored AP has not been discovered in the AP search, it proceeds to step S705.

In step S705, the control unit 101 refers to the connection device information 410 and determines whether or not there is a history of formation of a wireless network associated with the connection device selected in step S701. For example, given the connection device information 410 shown in FIG. 4A, if “mobilePhone1” 411 is selected in step S701, a network formation parameter number is associated, and therefore the control unit 101 proceeds to step S706. On the other hand, if “mobilePhone2” 412 is selected in step S701, a network formation parameter number is not associated, and therefore the control unit 101 proceeds to step S707.

In step S706, the control unit 101 refers to the connection device information 410 and identifies a wireless network formation parameter number associated with the connection device selected in step S701. Then, it refers to and reads a network formation parameter 430, and proceeds to step S717. For example, given the connection device information 410 and network formation parameter 430 shown in FIGS. 4A and 4C, if “mobilePhone1” 411 is selected in step S701, the column 431 with a network formation parameter number 1 is associated. Therefore, the control unit 101 refers to the network formation parameter 430 with the network formation parameter number 1 in the column 431, and reads an ESSID “CAMERA-123” and an encryption key “12345678”. Also, as stated earlier, in the present embodiment, the digital camera 100 stores a parameter for a case in which the encryption setting is enabled, and therefore the read network parameter is a parameter for a case in which the encryption setting is enabled.

A process of step S707 is similar to the process of step S504 shown in FIG. 5A, and therefore a description thereof is omitted. In step S717, the control unit 101 judges whether or not the encryption setting of a wireless LAN network to be formed is disabled. If the control unit 101 judges that the encryption setting of the wireless LAN network to be formed is disabled, it proceeds to step S718 and executes a process for converting the network parameter. On the other hand, if the control unit 101 judges that the encryption setting of the wireless LAN network to be formed is enabled, it proceeds to step S708 and executes a wireless LAN network formation process.

In step S718, the control unit 101 converts the network parameter read in step S706 or the network parameter generated in step S707. It should be noted that, as stated earlier, in the present embodiment, the digital camera 100 reads or generates a network parameter for a case in which the encryption setting is enabled, and converts the read or generated network parameter when it is judged in step S717 that the encryption setting of the wireless LAN network to be formed is disabled.

In step S708, the control unit 101 forms a wireless LAN network using the network parameter read in step S706, the network parameter generated in step S707, or the network parameter converted in step S718. That is to say, the control unit 101 executes a process for newly forming a network based on the simple AP and making a connection partner join in the network. From here on, a process similar to the process of step S505 shown in FIG. 5A is executed, and therefore a description thereof is omitted. The control unit 101 proceeds to step S721. If it is determined in step S705 that there is a history of formation of a wireless network, a wireless LAN network is formed by referring to a network formation parameter 430 for the following reason. In the case of connection to a connection device for the second time onward, if the digital camera 100 forms a network that is the same as a previous one, the connection device can execute connection processing using a stored network parameter and save the user the trouble of inputting an encryption key and the like again.

Processes of step S709 to step S716 are similar to the processes of step S506 to step S513 shown in FIG. 5A, and therefore a description thereof is omitted. In step S713, if the control unit 101 determines that it has failed in connection to the wireless LAN network, it proceeds to step S716. In step S715, if the control unit 101 determines that it has succeeded in allocating an IP address, it proceeds to step S721. If the control unit 101 determines that it has failed in the allocation of the IP address, it proceeds to step S716. After error is displayed in step S716, if the control unit 101 is notified of confirmation of the substance of the error by the user of the digital camera 100, it proceeds to step S731.

With reference to FIG. 7B, the following describes processing of the digital camera 100 at the time of connecting to a connection device for the second time onward.

Referring to FIG. 7B, in step S721, the control unit 101 searches for the connection device selected in step S701 from among connectable devices within the same network. The detail of the process of the search method is similar to the process of step S521 shown in FIG. 5B, and therefore a description thereof is omitted. The control unit 101 refers to the connection device information 410 and searches for a connectable device whose UUID matches the UUID of the connection device selected in step S701. For example, given the connection device information 410 shown in FIG. 4A, if “mobilePhone1” 411 is selected in step S701, a connectable device with a UUID “0000-ABCD-EFGH” is searched for. FIGS. 6D and 6F show examples of screens that are displayed on the display unit 106 while searching for the connectable device.

In step S722, the control unit 101 determines whether or not the device selected in step S701 has been discovered from among connectable devices. If the control unit 101 determines that the device selected in step S701 has been discovered, it proceeds to step S724. If the control unit 101 determines that the device selected in step S701 has not been discovered, it proceeds to step S723.

A process of step S723 is similar to the process of step S523 shown in FIG. 5B, and therefore a description thereof is omitted. In step S723, if the control unit 101 determines that an instruction for changing a network has been issued, it proceeds to step S731. If the control unit 101 determines that the instruction for changing a network has not been issued, it proceeds to step S721.

In step S724, the control unit 101 transmits a connection request to the mobile telephone 200 using the UUID of the device selected in step S701, and starts a process for establishing the connection with the selected device. The control unit 101 proceeds to step S725. The detail of the process for establishing the connection is similar to the process of step S526 shown in FIG. 5B, and therefore a description thereof is omitted. FIG. 6H shows an example of a screen that is displayed on the display unit 106 if “mobilePhone1” is selected in step S701.

Processes of step S725 and step S726 are similar to the processes of step S527 and step S528 shown in FIG. 5B, and therefore a description thereof is omitted. In step S726, if the control unit 101 determines that the currently-connected wireless LAN network is a network that the digital camera 100 formed by itself, it proceeds to step S727. If the control unit 101 determines that the currently-connected wireless LAN network is not a network that the digital camera 100 formed by itself, it proceeds to step S729.

In step S727, the control unit 101 determines whether or not a network parameter was generated in step S707. If the control unit 101 determines that the network parameter was generated, it proceeds to step S728 and stores the network parameter. If the control unit 101 determines that the network parameter was not generated, it proceeds to step S729.

In step S728, the control unit 101 stores a parameter of the network that the digital camera 100 formed by itself as a network formation parameter 430, and ends the connection for the second time. For example, assume a case in which, given a network formation parameter shown in FIG. 4C, “mobilePhone2” is selected in step S701 and the network formed by the digital camera 100 has an ESSID “CAMERA-456” and an encryption key “11112222”. In this case, the ESSID “CAMERA-456” and the encryption key “11112222” are stored as a network formation parameter 430 with a network formation parameter number 2 in a column 432. Also, as stated earlier, in the present embodiment, the control unit 101 stores a parameter for a case in which the encryption setting is enabled. Therefore, when the encryption setting is disabled, the control unit 101 stores a network parameter prior to the network parameter conversion in step S718 shown in FIG. 7A as a network formation parameter 430.

In step S729, the control unit 101 updates a parameter of the connection device in the connection device information 410. For example, given the connection device information 410 shown in FIG. 4A, if “mobilePhone2” is selected in step S701, “7” is stored under a connection order of connection device information 410 with a connection device information number 2 in a column 412, which is a value larger than connection orders of other connection device information. Also, if the network parameter was generated in step S707, a network formation parameter number of the network formation parameter 430 stored in step S728 is stored as a network formation parameter number of the column 412 with the connection device information number 2. In this way, the same wireless LAN parameter can be used when establishing connection with “mobilePhone2” by forming a network next time.

With reference to FIG. 7C, the following describes processing of the digital camera 100 at the time of execution of connection processing (network change) for the second time.

Referring to FIG. 7C, processes of step S731 to step S733 are similar to the processes of step S541 to step S543 shown in FIG. 5C, and therefore a description thereof is omitted. In step S733, if the control unit 101 determines that it will join in a wireless LAN network, it proceeds to step S738. If the control unit 101 determines that it will not join in a wireless LAN network, it proceeds to step S734.

Processes of step S734 to step S737, step S746, and step S747 are similar to the processes of step S705 to step S708, step S717, and step S718, and therefore a description thereof is omitted. After the process of step S737, the control unit 101 proceeds to step S721.

Processes of step S738 to step S745 are similar to the processes of step S546 to step S553 shown in FIG. 5C, and therefore a description thereof is omitted. After the process of step S743, the control unit 101 proceeds to step S721. After the process of step S744, the control unit 101 proceeds to step S721. After the error is displayed in step S745, if the control unit 101 is notified of confirmation of the substance of the error by the user of the digital camera 100, it proceeds to step S731.

As described above, upon designation of an apparatus having a connection history, the digital camera 100 according to the present embodiment starts to join in an appropriate network, and after the participation in the network, connects to the designated apparatus. From a user's point of view, by selecting a device to which the user wishes to connect, a sequence of processes from participation in the network to connection to the device is appropriately executed; therefore, usability can be improved.

Also, a network identifier used by the digital camera 100 differs between when the encryption setting of a wireless network formed by itself is enabled and when the encryption setting is disabled. In this way, when the encryption setting of the wireless network is changed, the loss of a network parameter stored in a wireless communication apparatus that connected to the pre-change wireless network can be suppressed.

### Second Embodiment

A second embodiment will now be described. In the second embodiment also, basic configurations of the digital camera 100 and the mobile telephone 200 are similar to those of the first embodiment (see FIGS. 1 and 2).

In the above-described first embodiment, a network identifier used by the digital camera 100 differs between when the encryption setting of a wireless network formed by itself is enabled and when the encryption setting is disabled. However, in some cases, depending on a hardware configuration of a connection device and a usage pattern of the user, the control unit 101 may display a warning statement in connection processing for the second time onward according to the circumstances. For example, when the digital camera 100 forms a network while serving as a simple AP using a network identifier that has never been used before (or a network identifier different from the one previously used), the control unit 101 may display a warning statement.

As mentioned in the background section, a wireless communication apparatus generally stores a network parameter of a wireless network in which it has joined at the time of participation in the wireless network. When the wireless communication apparatus joins in the same wireless network for the second time onward, it refers to and uses the stored network parameter. Furthermore, upon detection of a beacon signal from an access point that forms a wireless network in which a wireless communication apparatus, represented by the mobile telephone 200 and the like, has joined in the past, the wireless communication apparatus may automatically join in the wireless network in which it has joined in the past. However, when the digital camera 100 forms a network using a network identifier that has never been used before, there is a possibility that the mobile telephone 200 does not automatically join in the network formed by the digital camera 100. This could possibly confuse the user of the mobile telephone 200.

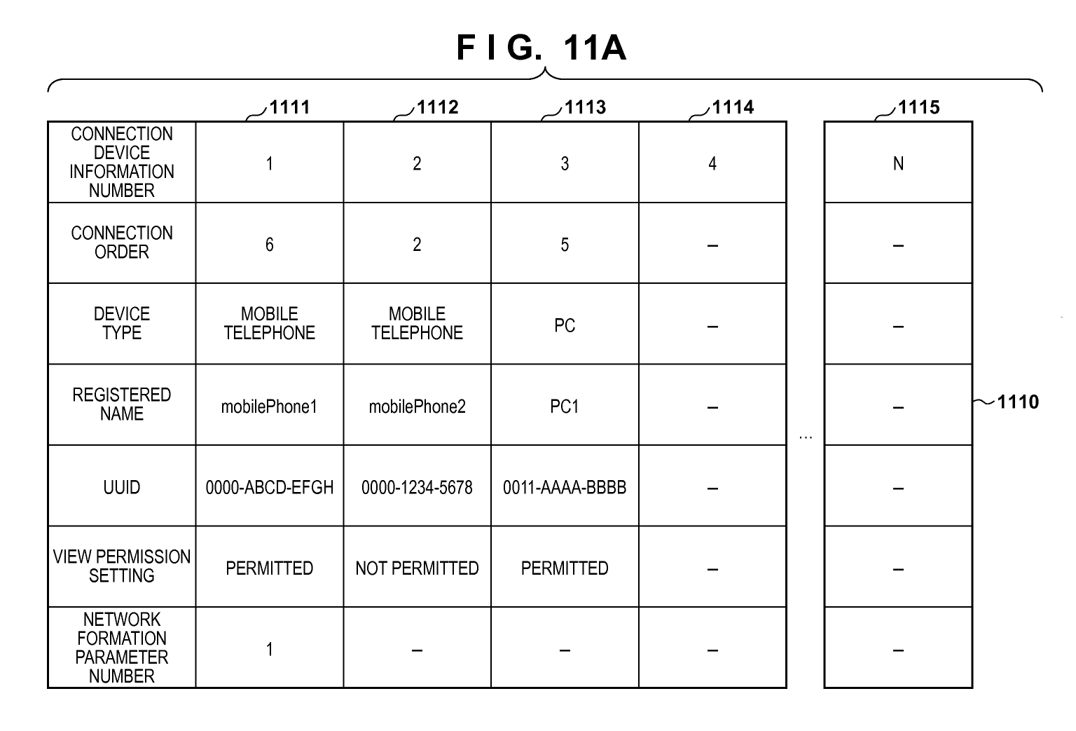

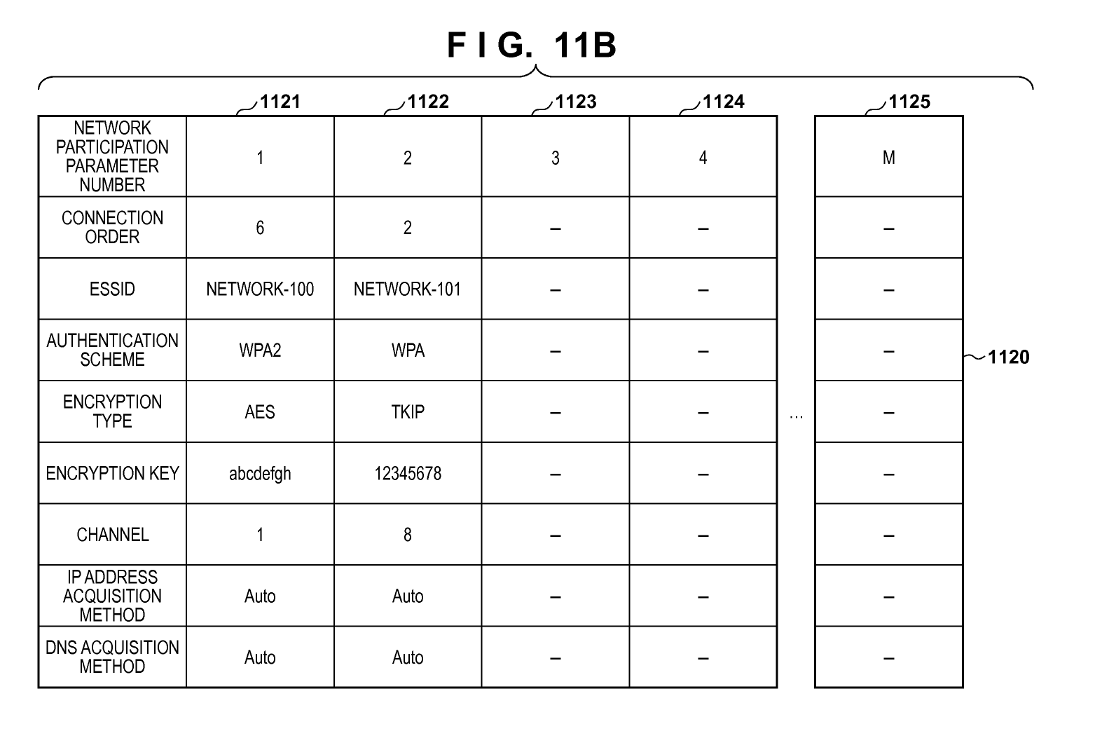

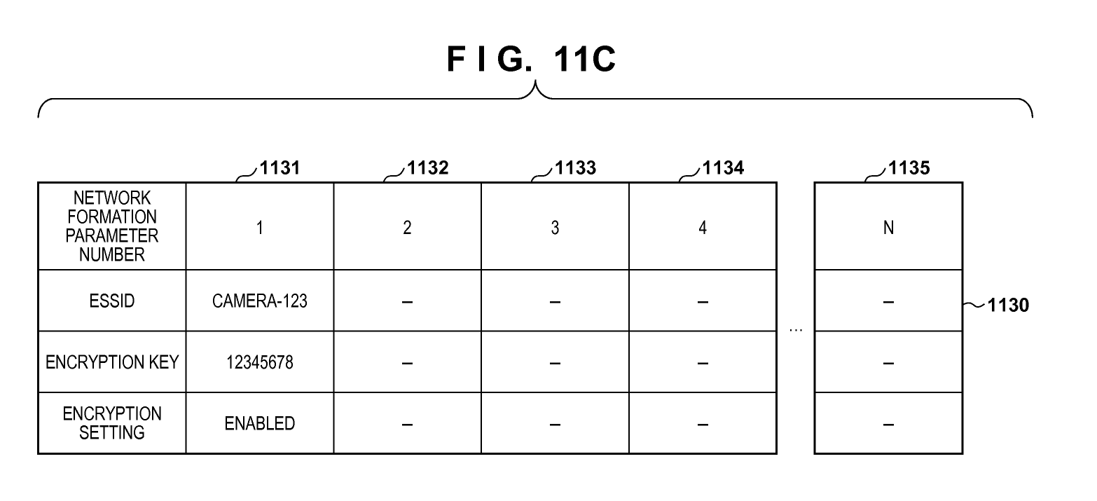

With reference to FIGS. 11A to 11C, the following describes databases retained by the digital camera 100 according to the present embodiment. Connection device information 1110, network participation parameters 1120, and network formation parameters 1130 are recorded in the databases retained by the digital camera 100 according to the present embodiment. The connection device information 1110 and the network participation parameters 1120 are similar to the connection device information 410 and the network participation parameters 420 shown in FIGS. 4A and 4B, and therefore a description thereof is omitted.

The network formation parameters 1130 are intended to manage information of networks that are formed by the digital camera 100 serving as a simple AP. A “network formation parameter number” assigned to each network formation parameter, an “ESSID”, an “encryption key”, and an “encryption setting” are stored in a network formation parameter 1130. An authentication scheme, an encryption type, a channel, an IP address acquisition method, a DNS acquisition method, and the like may be stored in a network formation parameter 1130, but items that are common to all networks formed by the digital camera 100 need not necessarily be stored. The “network formation parameter number”, “ESSID”, and “encryption key” have already been described with reference to FIG. 4C, and therefore a description thereof is omitted. The “encryption setting” stores whether the encryption setting was “enabled” or “disabled” when the digital camera 100 formed a network using an ESSID of the corresponding network formation parameter number for the first time. Alternatively, the “encryption setting” may store whether the encryption setting was “enabled” or “disabled” when the digital camera 100 formed a network previously using an ESSID of the corresponding network formation parameter number.

Although processing in which the digital camera 100 communicates with the mobile telephone 200 is mostly similar to that of the first embodiment (see FIGS. 5A to 5C and FIGS. 7A to 7C), a part of the processing related to the “encryption setting” of a network formation parameter 1130 is different.

First, in step S529 of FIG. 5B and step S728 of FIG. 7B, the control unit 101 stores “enabled” or “disabled” under the “encryption setting” of a network formation parameter 1130 in accordance with the encryption setting of the formed network.

In step S708 of FIG. 7A (in a case where it is preceded by step S706), the control unit 101 judges whether or not the “encryption setting” stored in a network formation parameter 1130 shown in FIG. 11C has the same value as the encryption setting configured using the password 801 shown in FIG. 8. If the control unit 101 judges that they have the same value, it displays the screen shown in FIG. 6D on the display unit 106 similarly to the first embodiment. That is to say, as indicated by reference numeral 610, the control unit 101 displays, on the display unit 106, the ESSID of the formed wireless network as well as a message for suggesting the user to activate an application of the mobile telephone 200. If the encryption setting is enabled, the control unit 101 also displays the encryption key on the display unit 106. On the other hand, if the control unit 101 judges that they do not have the same value, it displays a screen shown in FIG. 6K on the display unit 106. That is to say, as indicated by reference numeral 623, the control unit 101 displays, on the display unit 106, information shown in FIG. 6D as well as a warning message to the effect that the ESSID has been changed from the first-time connection. When the warning message is displayed, the control unit 101 deletes the “encryption setting” of a network formation parameter 1130. In this way, a warning message is displayed only when an ESSID different from an ESSID of the first-time connection is used for the first time. Alternatively, the control unit 101 may rewrite the “encryption setting” of a network formation parameter 1130 with the current encryption setting. In this case, the “encryption setting” of a network formation parameter 1130 indicates whether the encryption setting was “enabled” or “disabled” when a network was formed previously. Each time the encryption setting is changed (that is to say, when using an ESSID different from the previous one), a warning message is displayed.

The wireless network formation process of step S737 shown in FIG. 7C (in a case where it is preceded by step S735) is similar to step S708 shown in FIG. 7A (in a case where it is preceded by step S706).

It should be noted that the warning message shown in FIG. 6K is merely one example, and other methods (e.g., the use of sound and the like) may be adopted to inform the user of the use of an ESSID different from the first-time (or previous) ESSID.

As described above, when a network is formed based on a network formation parameter 1130 in a particular column shown in FIG. 11C, the digital camera 100 according to the present embodiment displays a warning message if an ESSID different from the first-time (or previous) ESSID is used. This makes it possible to avoid confusion for the user of the mobile telephone 200.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-005445, filed Jan. 15, 2014, which is hereby incorporated by reference herein in its entirety.

What is claimed is:

1. A communication apparatus comprising:
a forming unit configured to form a wireless network in which the communication apparatus functions as a relay apparatus and in which a communication partner apparatus is able to join using a network identifier of the wireless network;
an encryption unit configured to encrypt communication in the wireless network; and
a setting unit configured to set whether or not to apply the encryption of the communication with the encryption unit in accordance with an instruction from a user, wherein
the forming unit forms a wireless network that has a different network identifier depending on whether or not the encryption of the communication is applied.

2. The communication apparatus according to claim 1, further comprising:
a generation unit configured to generate a network identifier;
a storage unit configured to store the generated network identifier; and
a conversion unit configured to convert the stored network identifier into a different network identifier, wherein
the forming unit forms a wireless network that has the stored network identifier when the encryption of the communication is applied, and forms a wireless network that has the converted network identifier when the encryption of the communication is not applied.

3. The communication apparatus according to claim 2, wherein
the generation unit generates encryption information,
the storage unit stores the generated encryption information, and
when the encryption of the communication is applied, the forming unit forms a wireless network to which the encryption of the communication is applied by the encryption unit in accordance with the stored encryption information.

4. The communication apparatus according to claim 2, wherein
the generation unit generates different network identifiers for each communication partner apparatus,
the storage unit stores the generated network identifiers in correspondence with the communication partner apparatuses,
the communication apparatus further comprises a selection unit configured to select a communication partner apparatus, and
the forming unit forms a wireless network that has a network identifier corresponding to the communication partner apparatus selected by the selection unit when the encryption of the communication is applied, and forms a wireless network that has a network identifier obtained by converting the corresponding network identifier with the conversion unit when the encryption of the communication is not applied.

5. The communication apparatus according to claim 4, wherein
the generation unit generates different pieces of encryption information for each communication partner apparatus,
the storage unit stores the generated pieces of encryption information in correspondence with the communication partner apparatuses, and
when the communication encryption is applied, the forming unit forms a wireless network to which the encryption of the communication is applied by the encryption unit in accordance with a piece of encryption information corresponding to the communication partner apparatus selected by the selection unit.

6. The communication apparatus according to claim 4, further comprising
a notification unit configured to, after the forming unit has formed for a first time a wireless network that has one of the network identifier corresponding to the communication partner apparatus selected by the selection unit and the network identifier obtained by converting the corresponding network identifier with the conversion unit, when the forming unit forms for a first time a wireless network that has the other of the network identifiers, notify the user of the first-time formation of the wireless network that has the other of the network identifiers.

7. The communication apparatus according to claim 1, wherein
the network identifier is an ESSID.

8. The communication apparatus according to claim 1, wherein
a network identifier of a wireless network formed when the encryption of the communication is applied and a network identifier of a wireless network formed when the encryption of the communication is not applied have a common part that is unique to the communication apparatus.

9. A control method for a communication apparatus, the control method comprising:
forming a wireless network in which the communication apparatus functions as a relay apparatus and in which a communication partner apparatus is able to join using a network identifier of the wireless network;
encrypting communication in the wireless network; and
setting whether or not to apply the encryption of the communication in the encrypting in accordance with an instruction from a user, wherein
in the forming, a wireless network is formed that has a different network identifier depending on whether or not the encryption of the communication is applied.

10. A non-transitory computer-readable storage medium which stores a program for causing a computer to execute the control method according to claim 9.
